(19) United States
(12) Patent Application Publication
(10) Pub. No.: US 2009/0159786 A1
(43) Pub. Date: Jun. 25, 2009

(54) DISPLAY APPARATUS AND ILLUMINATION APPARATUS

(75) Inventors: Ying Bao YANG, Kanagawa (JP); Masumitsu Ino, Kanagawa (JP); Tsutomu Tanaka, Kanagawa (JP); Kazunori Yamaguchi, Kanagawa (JP); Masaru Higuchi, Tokyo (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: Sony Corporation, Tokyo (JP)

(21) Appl. No.: 12/329,762

(22) Filed: Dec. 8, 2008

(30) Foreign Application Priority Data
Dec. 19, 2007 (JP) 2007-327953
Oct. 7, 2008 (JP) 2008-260906

(51) Int. Cl. G01J 1/42

(52) U.S. Cl. 250/227.29

(57) ABSTRACT

A display apparatus includes: a display panel including a plurality of pixels laid out on the surface of a pixel area of the display panel; and an illumination section configured to generate illumination light in a normal direction perpendicular to the display panel, wherein the illumination section has a light source, a light guiding board, the display panel also includes a plurality of photo sensor devices, the light source includes an invisible light source, the light guiding board includes an invisible light beam reflection section.

### CROSS REFERENCES TO RELATED APPLICATIONS

The present invention contains subject matter related to Japanese Patent Application JP 2008-260906 and JP 2007-327953 both filed in the Japan Patent Office on Oct. 7, 2008, and on Dec. 19, 2007, the entire contents of which being incorporated herein by reference.

### BACKGROUND OF THE INVENTION

1. Field of the Invention

In general, the present invention relates to a display apparatus and an illumination apparatus. In particular, the present invention relates to a display apparatus which has a display panel employing a plurality of pixels laid out on the surface of a pixel area on the display panel, includes a plurality of photo sensor devices also arranged in the pixel area to serve as devices each used for receiving light propagating in a direction parallel to the direction from the front-surface side of the display panel to the rear-surface side of the display panel and functions as an apparatus for displaying an image in the pixel area on the front-surface side. In addition, the present invention also relates to an illumination apparatus having an illumination section for radiating illumination light in a normal direction perpendicular to the display panel.

2. Description of the Related Art

A display apparatus such as a liquid-crystal display apparatus or an EL (Electro Luminescence) display apparatus offers merits such as being thin, being light and a low power consumption. For more information on such a display apparatus, the reader is suggested to refer to Japanese Patent Laid-open No. 2007-249241 and Japanese Patent Laid-open No. 2007-227117.

Such a display apparatus like a liquid-crystal display apparatus employs a liquid-crystal panel, which includes a liquid-crystal layer sealed between 2 substrates forming a substrate pair, as a display panel. The liquid-crystal panel is for example a transmission-type panel which modulates illumination light radiated thereto by an illumination apparatus provided on the rear-surface side of the liquid-crystal panel before passing on the modulated illumination light. A typical example of the illumination apparatus is a backlight. The modulated illumination light passed on by the liquid-crystal panel appears on the front surface of the liquid-crystal panel as the display of an image.

The liquid-crystal panel for example has a TFT (Thin Film Transistor) array substrate on which a plurality of TFTs each functioning as a pixel switching device are created to implement a driving method such as an active matrix method. In addition, the liquid-crystal panel also employs a facing substrate exposed to the TFT array substrate. A liquid crystal layer is provided between the facing substrate and the TFT array substrate, being sandwiched by the facing substrate and the TFT array substrate. In the liquid-crystal panel adopting the active matrix method, when a TFT serving as a pixel switching device for switching a pixel supplies an electric potential to a pixel electrode of the pixel, a voltage applied to the liquid-crystal layer changes, controlling the transmissivity of light passing through the pixel. As a result, the light is modulated.

There has been also proposed a typical liquid-crystal panel which includes photo sensor devices embedded in a pixel area of the liquid-crystal panel to serve as photo sensor devices each used for obtaining data of received incoming light by receiving the incoming light in addition to the TFTs each functioning a pixel switching device as described above.

By making use of each of the embedded photo sensor devices as an imaging sensor device for example, it is possible to implement the function of a biometric authentication apparatus. For more information on the imaging sensor device and the function of the biometric authentication apparatus, the reader is suggested to refer to documents such as Japanese Patent No. 3742846.

In addition, the liquid-crystal panel may make use of each of the embedded photo sensor devices as a position-sensor device in order to implement a user interface. For more information on the position-sensor device and the user interface, the reader is suggested to refer to documents such as Japanese Patent Laid-open No. 2007-128497. For this reason, the liquid-crystal panel is referred to as an I/O (Integrated-Optical) touch panel.

In the case of a liquid-crystal panel of this type, it is no longer necessary to separately provide a touch panel adopting a resistive film method or an electrostatic capacitance method on the front surface of the liquid-crystal panel. Thus, it is possible to easily reduce the size and/or thickness of a liquid-crystal display apparatus employing the liquid-crystal panel. In addition, in the case of a liquid-crystal panel provided with a separately constructed touch panel adopting a resistive film method or an electrostatic capacitance method, there may be raised problems that the amount of light passing through the pixel area of the liquid-crystal panel decreases or there are interference between the light passing through the pixel area and light hitting the touch panel. With a liquid-crystal panel including photo sensor devices embedded in the pixel area of the liquid-crystal panel, on the other hand, these problems can be solved.

In the case of a liquid-crystal panel including photo sensor devices embedded in a pixel area of the liquid-crystal panel, incoming visible light reflected by a detection subject such as a finger touching the front surface of the liquid-crystal panel is received by the photo sensor devices. Later on, on the basis of received-light data generated by the photo sensor devices from the received incoming visible light, a location touched by the subject of detection can be identified. Then, the liquid-crystal display apparatus itself or another electronic instrument connected to the liquid-crystal display apparatus carries out an operation corresponding to the touched location on the liquid-crystal panel. As an alternative, on the basis of the received-light data generated by the photo sensor devices, a biometric authentication can be carried out on the subject of detection.

As is obvious from the above description, an electrical signal representing received-light data generated by the photo sensor devices embedded in the display panel may include noises in some cases due to the influence of visible light included in external light. In addition, if a black display is implemented on the pixel area of the liquid-crystal panel, it is difficult for the photo sensor devices provided on the TFT array substrate to receive visible light radiated by a subject of detection. It is thus hard in some cases to detect the position of the subject of detection with a high degree of precision.

In order to solve the problems described above, there has been proposed a technology of making use of an illumination apparatus having an invisible light source for radiating invisible light other than visible light. A typical example of the invisible light is the infrared light. For more information on this technology, the reader is suggested to refer to documents such as Japanese Patent Laid-open No. 2004-318819.

### SUMMARY OF THE INVENTION

Since an electrical signal representing received-light data generated by the photo sensor devices includes many noises, however, it is difficult to generate the signal representing the received-light data with a sufficiently high S/N ratio in some cases. It is thus hard in some cases to carry out a process to detect the position of a detection subject and/or a biometric authentication process with a high degree of precision.

In order to solve the problems described above, the present embodiment provides a display apparatus capable of increasing the S/N ratio of an electrical signal representing received-light data so as to allow a process to detect the position of a detection subject and/or a biometric authentication process to be carried out with a high degree of precision and provides an illumination apparatus having functions similar to those of an illumination section employed in the display apparatus.

A display apparatus provided by the present embodiment employs a display panel including a plurality of pixels laid out on the surface of a pixel area of the display panel and an illumination section for generating illumination light in a normal direction perpendicular to the display panel. The illumination section has a light source for radiating original light and a light guiding board which is exposed to a surface of the display panel. The original light generated by the light source hits an incidence surface of the light guiding board and the original light hitting the incidence surface is guided to a radiation surface of the light guiding board to be radiated from the radiation surface as the illumination light. The display panel also includes a plurality of photo sensor devices also arranged in the pixel area to serve as devices each used for receiving incoming light propagating in a direction parallel to the direction from the front-surface side of the display panel to the rear-surface side of the display panel and functions as a panel for displaying an image in the pixel area on the front-surface side.

The light source includes an invisible light source for generating an invisible light beam as the original light cited above. The light guiding board includes an invisible light beam reflection section for reflecting the invisible light beam generated by the invisible light source in a direction parallel to the direction from the rear-surface side of the display panel to the front-surface side of the display panel. The invisible light beam reflection section is provided at a location corresponding to an area included in the pixel area in which the photo sensor devices are created. The invisible light beam reflected by the invisible-light beam reflection section is radiated from the radiation surface of the light guiding board as the illumination light.

It is preferable to configure the invisible light source to generate an infrared light beam as the invisible light beam.

It is preferable to configure the display apparatus to further employ a biometric authentication section for authenticating a biological subject located on the front-surface side of the display panel. In this case, the biological subject reflects the illumination light, which has been generated by the illumination section, in the direction parallel to the direction from the front-surface side of the display panel to the rear-surface side of the display panel. The photo sensor devices receive the reflected illumination light as the incoming light and generate received-light data from the reflected illumination light. The biometric authentication section authenticates the biological object on the basis of the received-light data.

It is preferable to configure the photo sensor devices to generate the received-light data by receiving the reflected light reflected from the illumination light reflected by blood flowing in the biological subject.

It is preferable to configure the display panel to employ: a first substrate provided on the rear-surface side; a second substrate exposed to the first substrate and separated away from the first substrate by a gap; and a liquid-crystal layer provided in the gap sandwiched by the first and second substrates to serve as a layer including uniformly oriented liquid-crystal molecules.

It is preferable to configure the display apparatus to employ the illumination section which is provided on the rear-surface side of the display panel.

It is preferable to provide a configuration in which a transmission-type liquid-crystal panel which is liquid-crystal panel of the transmission type is used as the display panel. The illumination section includes a visible light source for generating a visible light beam, and the light guiding board guides the visible light beam, which is radiated by the visible light source to the incidence surface, and the invisible light beam, which is radiated by the invisible light source to the incidence surface, to the radiation surface as the illumination light to the transmission-type liquid-crystal panel functioning as the transmission-type liquid-crystal panel in order to display an image in the pixel area of the display panel.

It is preferable to configure the invisible light beam reflection section to have an invisible light beam reflection layer including an invisible light beam reflection pigment for reflecting the invisible light beam generated by the invisible light source.

It is preferable to configure the invisible light beam reflection section to include a plurality of aforementioned invisible light beam reflection layers created at a location corresponding to an area included in the pixel area, in which the photo sensor devices are created, by separating the invisible light beam reflection layers from each other.

It is preferable to configure the invisible light beam reflection section to employ a diffraction lattice section for diffracting the invisible light beam and a reflection section for reflecting the invisible light beam diffracted by the diffraction lattice section.

It is preferable to configure the invisible light beam reflection section to include a plurality of aforementioned diffraction lattice sections created at a location corresponding to an area included in the pixel area, in which the photo sensor devices are created, by separating the diffraction lattice sections from each other.

It is preferable to provide the illumination section on the front-surface side of the display panel.

It is preferable to configure the invisible light beam reflection section to include a prism surface for reflecting the invisible light beam generated by the invisible light source in the direction parallel to the direction from the rear-surface side of the display panel to the front-surface side of the display panel.

It is preferable to configure the invisible light beam reflection section to have an invisible light beam reflection layer including an invisible light beam reflection pigment for reflecting the invisible light beam.

It is preferable to configure the invisible light beam reflection section to include a plurality of aforementioned invisible light beam reflection layers created at a location corresponding to an area included in the pixel area, in which the photo sensor devices are created, by separating the invisible light beam reflection layers from each other.

It is preferable to make use of a liquid-crystal panel of the reflection type as the display panel.

It is preferable to make use of an EL panel as the display panel.

An illumination apparatus employing an illumination section for generating illumination light in a normal direction perpendicular to a display panel provided with a plurality of pixels, which are laid out on the surface of a pixel area, and provided with a plurality of photo sensor devices, which are also arranged in the pixel area to serve as devices each used for generating received-light data by receiving incoming light propagating in a direction parallel to the direction from the front-surface side of the display panel to the rear-surface side of the display panel, to serve as a panel for displaying an image on the front-surface side.

The illumination section has a light source for radiating original light and a light guiding board which is exposed to a surface of the display panel so as to direct the original light generated by the light source to hit an incidence surface of the light guiding board and guide the original light hitting the incidence surface to a radiation surface of the light guiding board to be radiated from the radiation surface as the illumination light.

The light source includes an invisible light source for generating an invisible light beam as the original light. The light guiding board includes an invisible light beam reflection section for reflecting the invisible light beam generated by the invisible light source in a direction parallel to the direction from the rear-surface side of the display panel to the front-surface side of the display panel. The invisible light beam reflection section is provided at a location corresponding to an area included in the pixel area in which the photo sensor devices are created. The invisible light beam reflected by the invisible-light beam reflection section is radiated from the radiation surface of the light guiding board as the illumination light.

In accordance with the present embodiment, the invisible light beam reflection section employed in the light guiding board reflects the invisible light beam generated by the invisible light source in a direction parallel to the direction from the rear-surface side of the display panel to the front-surface side of the display panel. The invisible light beam reflection section is provided at a location corresponding to an area included in the pixel area in which the photo sensor devices are created. The invisible light beam reflected by the invisible-light beam reflection section is radiated from the radiation surface as the illumination light.

In accordance with the present embodiment, a display apparatus is made capable of increasing the S/N ratio of an electrical signal representing received-light data so as to allow a process to detect the position of a detection subject and/or a biometric authentication process to be carried out with a high degree of precision and an illumination apparatus is provided to serve as an apparatus having functions similar to those of an illumination section employed in the display apparatus.

### BRIEF DESCRIPTION OF THE DRAWINGS

FIG. 1 is a cross-sectional diagram showing a cross section of the configuration of a liquid-crystal display apparatus according to a first embodiment of the present invention;

FIG. 2 is a diagram showing the top view of the liquid-crystal panel employed in the first embodiment of the present invention;

FIG. 3 is a cross-sectional diagram showing a model of a pixel created in the pixel area of the liquid-crystal panel employed in the first embodiment of the present invention;

FIG. 4 is a top-view diagram showing a model of a pixel created in the pixel area of the liquid-crystal panel employed in the first embodiment of the present invention;

FIG. 5 is a diagram showing an enlarged cross section of a pixel switching device employed in the first embodiment of the present invention;

FIG. 6 is a diagram showing an enlarged cross section of a photo sensor device employed in the first embodiment of the present invention;

FIG. 7 is a cross-sectional diagram showing a model of a backlight employed in the first embodiment of the present invention;

FIG. 8 is a diagram showing a perspective view of the backlight employed in the first embodiment of the present invention;

FIG. 9 is a diagram showing curves each representing a relation between the spectral reflection factor of an infrared light beam reflection pigment used in an infrared light beam reflection layer in the first embodiment of the present invention and the wavelength of light hitting the infrared light beam reflection layer;

FIG. 10 is a cross-sectional diagram showing a model of a state of the liquid-crystal panel and the backlight during a biometric authentication process carried out by the liquid-crystal display apparatus according to the first embodiment of the present invention on the basis received-light data obtained by receiving light which is reflected by a detection subject such as a finger of the user when the detection subject is brought into contact with the pixel area of the liquid-crystal panel or approaches the pixel area;

FIG. 11 is a side-view diagram conceptually showing a state in which light generated by a light source hits an infrared-light-beam reflection pigment particle included in an infrared light beam reflection layer employed in the first embodiment of the present invention;

FIG. 12 is a side-view diagram conceptually showing a state in which the light generated by the light source does not hit an infrared-light-beam reflection pigment particle included in the infrared light beam reflection layer employed in the first embodiment of the present invention;

FIG. 13 is a cross-sectional diagram showing a model of a backlight in a second embodiment of the present invention;

FIG. 14 is a perspective-view diagram showing a model of the backlight according to the second embodiment of the present invention;

FIG. 15 is a diagram showing an enlarged perspective view of a diffraction lattice section in the second embodiment of the present invention;

FIG. 16 is a cross-sectional diagram showing a model of a state of the liquid-crystal panel and the backlight during a biometric authentication process carried out by a liquid-crystal display apparatus according to the second embodiment of the present invention on the basis of received-light data obtained from the reflected light which is reflected by the detection subject such a finger of the user when the detection subject is brought into contact with the pixel area of the liquid-crystal panel or approaches the pixel area;

FIG. 17 is a diagram showing a cross section of the configuration of a liquid-crystal display apparatus according to a third embodiment of the present invention;

FIG. 18 is a cross-sectional diagram showing a model of a backlight employed in the third embodiment of the present invention;

FIG. 19 is a perspective-view diagram showing a model of main components composing the backlight employed in the third embodiment of the present invention;

FIG. 20 is a cross-sectional diagram showing a model of a front-light employed in the third embodiment of the present invention;

FIG. 21 is a perspective-view diagram showing a model of main components composing the front-light employed in the third embodiment of the present invention;

FIG. 22 is a cross-sectional diagram showing a model of a state of a liquid-crystal panel and the front-light during a biometric authentication process carried out by the liquid-crystal display apparatus according to the third embodiment of the present invention on the basis received-light data obtained by receiving light which is reflected by a detection subject such as a finger of the user when the detection subject is brought into contact with the pixel area of the liquid-crystal panel or approaches the pixel area;

FIG. 23 is a cross-sectional diagram showing a model of a front-light employed in a fourth embodiment of the present invention;

FIG. 24 is a perspective-view diagram showing a model of main components composing the front-light employed in the fourth embodiment of the present invention;

FIG. 25 is a cross-sectional diagram showing a model of a state of the liquid-crystal panel and the front-light during a biometric authentication process carried out by the liquid-crystal display apparatus according to the fourth embodiment of the present invention on the basis received-light data obtained by receiving light which is reflected by a detection subject such as a finger of the user when the detection subject is brought into contact with the pixel area of the liquid-crystal panel or approaches the pixel area;

FIG. 26 is a diagram showing a cross section of the configuration of a liquid-crystal display apparatus according to a fifth embodiment of the present invention;

FIG. 27 is a cross-sectional diagram showing an approximate model of the pixel provided in the pixel area of a liquid-crystal panel employed in the fifth embodiment of the present invention;

FIG. 28 is a diagram showing a cross section of the configuration of an EL display apparatus according to a sixth embodiment of the present invention;

FIG. 29 is a cross-sectional diagram showing a model of one of a plurality of pixels located in the pixel area of an EL panel employed in the sixth embodiment of the present invention;

FIG. 30 is a cross-sectional diagram showing a model of a state of the EL panel and the front-light during a biometric authentication process carried out by the EL display apparatus according to the sixth embodiment of the present invention on the basis received-light data obtained by receiving light which is reflected by a detection subject such as a finger of the user when the detection subject is brought into contact with the pixel area of the liquid-crystal panel or approaches the pixel area;

FIG. 31 is a cross-sectional diagram showing a modified version of the configuration of a pixel switching device according to another embodiment of the present invention;

FIG. 32 is a diagram showing a TV set employing a liquid-crystal display apparatus according to an embodiment of the present invention;

FIG. 33 is a diagram showing a digital still camera employing a liquid-crystal display apparatus according to an embodiment of the present invention;

FIG. 34 is a diagram showing a notebook personal computer employing a liquid-crystal display apparatus according to an embodiment of the present invention;

FIG. 35 is a diagram showing a cellular phone employing a liquid-crystal display apparatus according to an embodiment of the present invention; and

FIG. 36 is a diagram showing a video camera employing a liquid-crystal display apparatus according to an embodiment of the present invention.

### DETAILED DESCRIPTION OF THE PREFERRED EMBODIMENTS

Typical embodiments of the present invention are explained by referring to diagrams as follows.

### First Embodiment

### (Configuration of a Liquid-Crystal Display Apparatus)

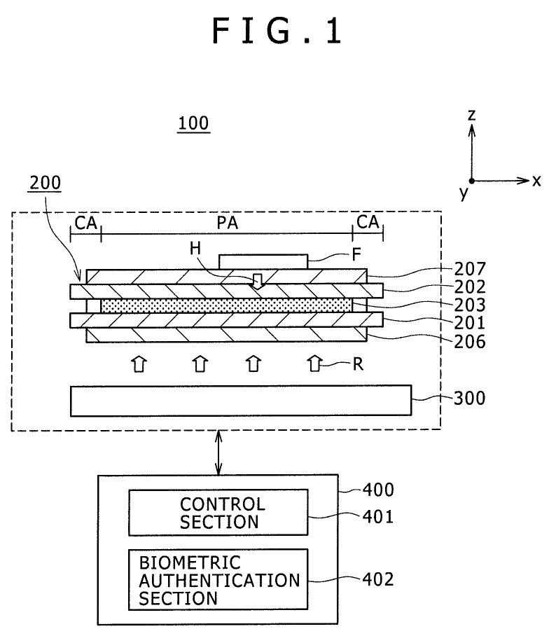

FIG. 1 is a cross-sectional diagram showing a cross section of the configuration of a liquid-crystal display apparatus 100 according to a first embodiment of the present invention.

As shown in the cross-sectional diagram of FIG. 1, the liquid-crystal display apparatus 100 according to the first embodiment employs a liquid-crystal panel 200, a backlight 300 and a data processing block 400 which are explained one after another as follows.

The liquid-crystal panel 200 adopts an active-matrix method. As shown in the cross-sectional diagram of FIG. 1, the liquid-crystal panel 200 employs a TFT array substrate 201, a facing substrate 202 and a liquid-crystal layer 203.

In the liquid-crystal panel 200, the TFT array substrate 201 and the facing substrate 202 are separated away from each other by a gap in which the liquid-crystal layer 203 is provided in a state of being sandwiched by the TFT array substrate 201 and the facing substrate 202.

The liquid-crystal panel 200 is a panel of the transmission type. As shown in the cross-sectional diagram of FIG. 1, the backlight 300 is provided on the side of the TFT array substrate 201. The backlight 300 radiates illumination light to a surface of the TFT array substrate 201 in the liquid-crystal panel 200. The surface to which the illumination light is radiated from the backlight 300 is the surface on the side opposite to the facing substrate 202 in the liquid-crystal panel 200.

The liquid-crystal panel 200 includes a pixel area PA for displaying an image. In the pixel area PA, a plurality of pixels not shown in the cross-sectional diagram of FIG. 1 are laid out. The backlight 300 provided on the rear-surface side of the liquid-crystal panel 200 radiates an illumination light beam R to the rear surface of the liquid-crystal panel 200 through a first polarization board 206. The illumination light beam R further propagates from the rear surface to the pixel area PA to be modulated in the pixel area PA as follows. On the TFT array substrate 201, a plurality of TFTs each serving as a pixel switching device not shown in the cross-sectional diagram of FIG. 1 are laid out so that each of the TFTs is located at a position of a pixel associated with the TFT. Each of the TFTs each serving as a pixel switching device is controlled to turn on and off or to put the pixel switching device in a turned-on and turned-off state in a process to modulate the illumination light beam R received from the rear surface. Then, the modulated illumination light beam R is radiated to the front-surface side through a second polarization board 207 in order to display an image in the pixel area PA. For example, a colored image is displayed on the front surface of the liquid-crystal panel 200.

In addition, as will be described later in detail, in the liquid-crystal panel 200 of this embodiment, a plurality of photo sensor devices not shown in the cross-sectional diagram of FIG. 1 are created. When a detection subject F is brought into contact with the front surface of the liquid-crystal panel 200 or approaches the front surface, the detection subject F reflects light radiated from the liquid-crystal panel 200 as reflected light H whereas the photo sensor devices receives the reflected light H which is reflected by the detection subject F. The front surface of the liquid-crystal panel 200 is a surface on a side opposite to the side on which the backlight 300 is provided. Typical examples of the detection subject F are a finger of the user or a touch pen. For example, a photodiode is used as each of the photo sensor devices. In this case, the photodiodes in the liquid-crystal panel 200 receive the reflected light H from the detection subject F such as a finger of the user. The reflected light H which is reflected by the detection subject F propagates from the side close to the facing substrate 202 to the side close to the TFT array substrate 201. The photo sensor devices carry out a photo-electrical process to convert the reflected light H into an electrical signal representing received-light data.

As shown in the cross-sectional diagram of FIG. 1, the backlight 300 is exposed to the rear surface of the liquid-crystal panel 200 and radiates the illumination light beam R to the pixel area PA of the liquid-crystal panel 200.

To put it concretely, outside the liquid-crystal panel 200, the backlight 300 is provided on a side close to the TFT array substrate 201 instead of being provided on a side close to the facing substrate 202 which composes the liquid-crystal panel 200 in conjunction with the TFT array substrate 201. The backlight 300 radiates the illumination light beam R to a surface of the TFT array substrate 201. The surface of the TFT array substrate 201 to which the illumination light beam R is radiated is the surface on the side opposite to the side of the other surface of the TFT array substrate 201. The other surface of the TFT array substrate 201 is a surface facing the facing substrate 202. That is to say, the backlight 300 generates the illumination light beam R in a direction parallel to the direction from the side of the TFT array substrate 201 to the side of the facing substrate 202. To put it more accurately, the backlight 300 generates the illumination light beam R in the normal direction z perpendicular to the surfaces of the liquid-crystal panel 200.

As shown in the cross-sectional diagram of FIG. 1, the data processing block 400 employs a control section 401 and a biometric authentication section 402. The data processing block 400 includes a computer which is configured to execute programs in order to control operations carried out by a variety of aforementioned sections employed in the liquid-crystal display apparatus 100.

The control section 401 employed in the data processing block 400 is configured to control operations carried out by the liquid-crystal panel 200 and the backlight 300. To be more specific, the control section 401 supplies control signals to the liquid-crystal panel 200 in order to control operations carried out by a plurality of pixel switching devices provided in the liquid-crystal panel 200. It is to be noted that the pixel switching devices themselves are not shown in the cross-sectional diagram of FIG. 1. For example, the control section 401 controls the execution of an operation to sequentially drive lines connected to the pixel switching devices. In addition, the control section 401 also supplies control signals to the backlight 300 in order to control operations carried out by the backlight 300 to generate the illumination light beam R. In this way, the control section 401 controls the operations carried out by the backlight 300 and the liquid-crystal panel 200 in order to display an image in the pixel area PA of the liquid-crystal panel 200.

On top of that, the control section 401 supplies control signals to the liquid-crystal panel 200 in order to control operations carried out by a plurality of photo sensor devices provided in the liquid-crystal panel 200. Each of the photo sensor devices serves as a position sensor device. It is to be noted that the photo sensor devices themselves are not shown in the cross-sectional diagram of FIG. 1. For example, the control section 401 controls the execution of an operation to sequentially drive lines connected to the photo sensor devices to collect the received-light data from the photo sensor devices.

The biometric authentication section 402 employed in the data processing block 400 is configured to carry out an imaging process of creating an image of a detection subject F coming into contact with the pixel area PA or approaching the pixel area PA on the front-surface side of the liquid-crystal panel 200 and carry out a biometric authentication process from an image obtained as a result of the imaging process. As described earlier, a finger of a human being is a typical subject of detection. In accordance with this embodiment, on the basis of received-light data collected from the photo sensor devices provided in the liquid-crystal panel 200 as devices also not shown in the cross-sectional diagram of FIG. 1, the biometric authentication section 402 carries out a biometric authentication process. For example, the photo sensor devices receive the reflected light H which is reflected by blood flowing through veins in a human finger serving as a detection subject F and generates received-light data on the basis of the reflected light H. Then, the biometric authentication section 402 carries out an image reconstruction process in order to generate a pattern image of the veins in the human finger. Subsequently, the biometric authentication section 402 carries out a biometric authentication process by extracting a pattern image corresponding to the generated pattern image from a memory used for pre-storing image patterns of fingers of a number of persons. For example, the biometric authentication section 402 carries out the biometric authentication process on the basis of characteristics of each image pattern. Finally, the biometric authentication section 402 retrieves data stored in the memory as data associated with the extracted pattern image. The data retrieved from the memory includes the name of a person owning the finger associated with the extracted pattern image.

### (Entire Configuration of the Liquid-Crystal Panel)

Next, the entire configuration of the liquid-crystal panel 200 is explained.

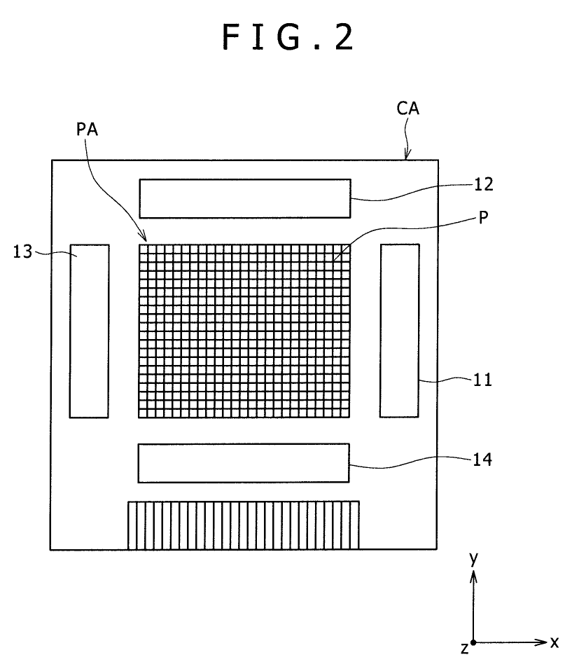

FIG. 2 is a diagram showing the top view of the liquid-crystal panel 200 employed in the first embodiment of the present invention.

As shown in the top-view diagram of FIG. 2, the liquid-crystal panel 200 has the pixel area PA mentioned above and a peripheral area CA.

As shown in the top-view diagram of FIG. 2, a plurality of pixels P are laid out on the surface of the pixel area PA in the liquid-crystal panel 200. To put it concretely, the pixels P are laid out in the horizontal direction x and the vertical direction y to form a matrix on which an image is to be displayed. As will be described later in detail, each of the pixels P includes a pixel switching device not shown in the top-view diagram of FIG. 2. In addition, a plurality of such photo sensor devices also not shown in the top-view diagram of FIG. 2 either are laid out in the pixel area PA in such a way that each of the photo sensor devices corresponds to one of the pixels P.

In the liquid-crystal panel 200, the peripheral area CA is placed at a location surrounding the pixel area PA as shown in the top-view diagram of FIG. 2. As shown in the top-view diagram of FIG. 2, circuits provided in the peripheral area CA include a display vertical driving circuit 11, a display horizontal driving circuit 12, a sensor vertical driving circuit 13 and a sensor horizontal driving circuit 14. Each of these circuits for example employs semiconductor devices created in the same way as every pixel switching device and every photo sensor device which are not shown in the top-view diagram of FIG. 2.

The pixel switching devices each provided in the pixel area PA for a pixel P are driven by the display vertical driving circuit 11 and the display horizontal driving circuit 12 in an operation to display an image in the pixel area PA. In the mean time, the photo sensor devices each provided in the pixel area PA for a pixel P are driven by the sensor vertical driving circuit 13 and the sensor horizontal driving circuit 14 in an operation to collect received-light data. As described above, neither the pixel switching devices nor the photo sensor devices are shown in the top-view diagram of FIG. 2.

To put it concretely, the display vertical driving circuit 11 is extended in the vertical direction y as shown in the top-view diagram of FIG. 2. The display vertical driving circuit 11 is connected to the gate electrodes of pixel switching devices each provided for a pixel P on each of columns which are arranged in the vertical direction y. As described earlier, the pixel switching devices themselves are not shown in the top-view diagram of FIG. 2. On the basis of a control signal received from the control section 401, the display vertical driving circuit 11 sequentially supplies scan signals to the gate electrodes of pixel switching devices provided on the columns which are arranged in the vertical direction y. To put it more concretely, the gate electrodes of the pixel switching devices each provided for a pixel P on each of the rows each oriented in the horizontal direction x are connected to a gate line wired to the display vertical driving circuit 11. The gate lines each corresponding to one of rows arranged in the vertical direction y to serve as columns each provided for pixels P sequentially receive a scan signal from the display vertical driving circuit 11. It is to be noted that the gate lines themselves are not shown in the top-view diagram of FIG. 2.

The display horizontal driving circuit 12 is extended in the horizontal direction x as shown in the top-view diagram of FIG. 2. The display horizontal driving circuit 12 is connected to the source electrodes of pixel switching devices each provided for a pixel P on each of rows which are arranged in the horizontal direction x. As described earlier, the pixel switching devices are not shown in the top-view diagram of FIG. 2. On the basis of a control signal received from the control section 401, the display horizontal driving circuit 12 sequentially supplies data signals to the source electrodes of pixel switching devices provided on the columns each oriented in the vertical direction y. To put it more concretely, the source electrodes of the pixel switching devices each provided for a pixel P on one of the columns each oriented in the vertical direction y are connected to a signal line wired to the display horizontal driving circuit 12. The signal lines each corresponding to one of the rows arranged in the horizontal direction x to serve as rows each provided for pixels P sequentially receives video data signal from the display horizontal driving circuit 12. It is to be noted that the signal lines themselves are not shown in the top-view diagram of FIG. 2

The sensor vertical driving circuit 13 is also extended in the vertical direction y as shown in the top-view diagram of FIG. 2. The sensor vertical driving circuit 13 is connected to photo sensor devices each provided for a pixel P on each of columns which are arranged in the vertical direction y. As described earlier, the photo sensor devices themselves are not shown in the top-view diagram of FIG. 2. On the basis of a control signal received from the control section 401, the sensor vertical driving circuit 13 sequentially supplies select signals to the photo sensor devices provided on the rows which are arranged in the vertical direction y. To put it more concretely, the photo sensor devices each provided for a pixel P on each of the rows each oriented in the horizontal direction x are connected to a gate line wired to the sensor vertical driving circuit 13 as a line for conveying a select signal generated by the sensor vertical driving circuit 13 as a signal for selecting one of the rows as a row of photo sensor devices from which received-light data to be described below is read out. The gate lines each corresponding to one of columns arranged in the vertical direction y to serve as columns each provided for pixels P sequentially receive a scan signal from the sensor vertical driving circuit 13. It is to be noted that the gate lines themselves are not shown in the top-view diagram of FIG. 2.

The sensor horizontal driving circuit 14 is also extended in the horizontal direction x as shown in the top-view diagram of FIG. 2. The sensor horizontal driving circuit 14 is connected to photo sensor devices each provided for a pixel P on each of rows which are arranged in the horizontal direction x. As described earlier, the photo sensor devices themselves are not shown in the top-view diagram of FIG. 2. On the basis of a control signal received from the control section 401, the sensor horizontal driving circuit 14 sequentially reads out received-light data from photo sensor devices provided on the columns each oriented in the vertical direction y and supplies the received-light data to the biometric authentication section 402. To put it more concretely, photo sensor devices each provided for a pixel P on one of the columns each oriented in the vertical direction y are connected to a signal read line wired to the sensor horizontal driving circuit 14. The signal read lines each corresponding to one of the rows arranged in the horizontal direction x to serve as rows each provided for pixels P sequentially transfer received-light data from the photo sensor devices to the sensor horizontal driving circuit 14. It is to be noted that the signal read lines themselves are not shown in the top-view diagram of FIG. 2.

### (Configuration of the Pixel Area in the Liquid-Crystal Panel)

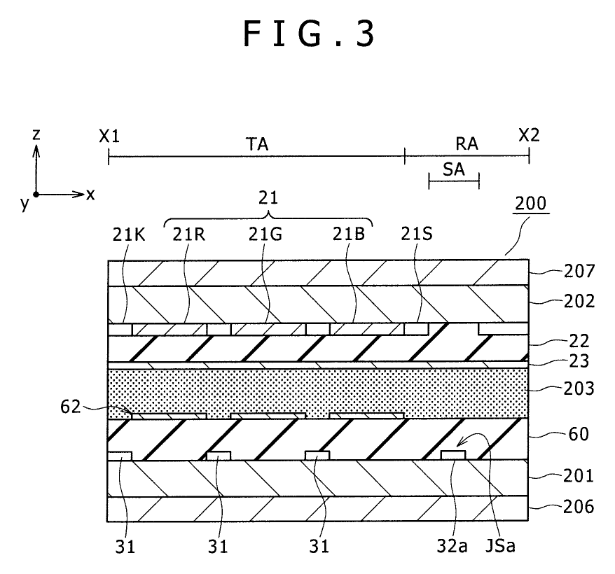

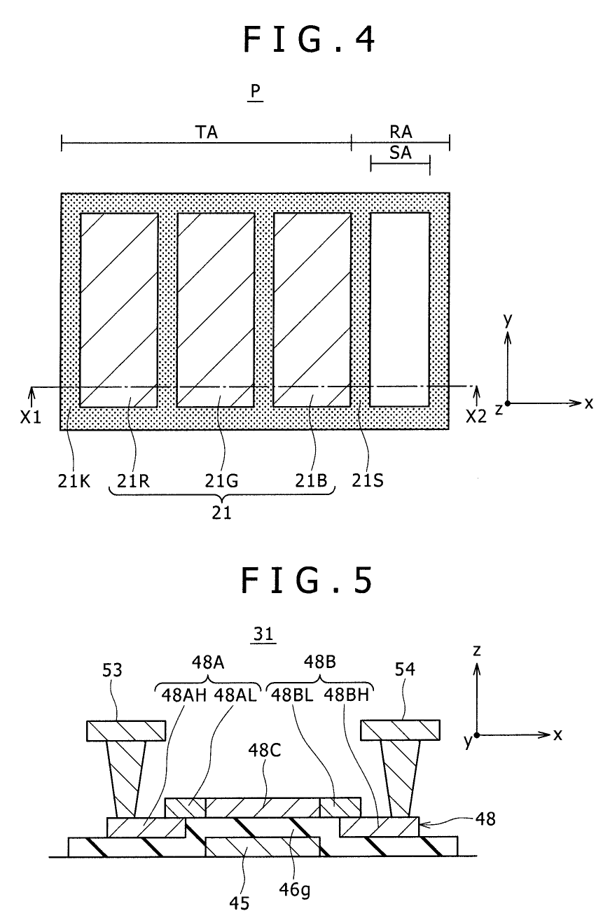

FIG. 3 is a cross-sectional diagram showing a model of a pixel P created in the pixel area PA of the liquid-crystal panel 200 employed in the first embodiment of the present invention. FIG. 4 is a top-view diagram showing a model of a pixel P created in the pixel area PA of the liquid-crystal panel 200 employed in the first embodiment of the present invention. The cross-sectional diagram of FIG. 3 shows a cross section at a location indicated by a dashed line denoted by notations X1 and X2 shown in the top-view diagram of FIG. 4.

As shown in the cross-sectional diagram of FIG. 3, the liquid-crystal panel 200 has the TFT array substrate 201, the facing substrate 202 and the liquid-crystal layer 203.

In the liquid-crystal panel 200, each of the TFT array substrate 201 and the facing substrate 202 is a substrate made of a semiconductor material which passes on light. For example, each of the TFT array substrate 201 and the facing substrate 202 is made of glass. The TFT array substrate 201 and the facing substrate 202 face each other and are separated away from each other by a spacer which is not shown in the cross-sectional diagram of FIG. 3. The TFT array substrate 201 and the facing substrate 202 are stuck to each other by making use of a sealing material also not shown in the cross-sectional diagram of FIG. 3. The liquid-crystal layer 203 is encapsulated in the gap between the TFT array substrate 201 and the facing substrate 202. On each of a particular surface of the TFT array substrate 201 and a specific surface of the facing substrate 202, a liquid-crystal orientation film also not shown in the cross-sectional diagram of FIG. 3 is provided as a film for orienting the liquid-crystal layer 203. For example, liquid-crystal molecules of the liquid-crystal layer 203 are oriented in the vertical direction.

As shown in the cross-sectional diagram of FIG. 3 and the top-view diagram of FIG. 4, the liquid-crystal panel 200 includes a display area TA and a sensor area RA.

As shown in the cross-sectional diagram of FIG. 3, for the display area TA, there are also created a color filter layer 21, a black matrix layer 21K, a facing electrode 23, a plurality of pixel switching devices 31 and a plurality of pixel electrodes 62. Illumination light generated by the backlight 300 penetrates the liquid-crystal panel 200 from the side of the TFT array substrate 201 to the side of the facing substrate 202 and displays an image on the display area TA.

Components of the display area TA are described as follows.

As shown in the cross-sectional diagram of FIG. 3, the color filter layer 21 is created on the specific surface of the facing substrate 202. As described above, the specific surface of the facing substrate 202 is a surface exposed to the TFT array substrate 201. As shown in the cross-sectional diagram of FIG. 3 and the top-view diagram of FIG. 4, the color filter layer 21 is created as a set of 3 color filter layers for 3 elementary colors, i.e., the red, green and blue colors. That is to say, the color filter layer 21 includes a red-color filter layer 21R, a green-color filter layer 21G and a blue-color filter layer 21B for the red, green and blue colors respectively. As shown in the top-view diagram of FIG. 4, each of the red-color filter layer 21R, the green-color filter layer 21G and the blue-color filter layer 21B has an oblong shape and are arranged in the horizontal direction x. In addition, each of the red-color filter layer 21R, the green-color filter layer 21G and the blue-color filter layer 21B is created as one of image segments separated away from each other by the black matrix layer 21K. On top of that, the red-color filter layer 21R, the green-color filter layer 21G and the blue-color filter layer 21B are configured to provide the red, green and blue colors respectively to the illumination light generated by the backlight 300 during its propagation from the side of the TFT array substrate 201 to the side of the facing substrate 202. For example, each of the red-color filter layer 21R, the green-color filter layer 21G and the blue-color filter layer 21B is created by, first of all, creating a coating film from coating liquid, which contains a coloring pigment corresponding to the color of the color filter layer and a photo resist material, by adoption of a coating method such as the spin coating method and, then, carrying out a pattern fabrication process based on a lithography technology on the coating film. In the process to create the red-color filter layer 21R, the green-color filter layer 21G and the blue-color filter layer 21B, for example, the polyimide resin is used as the photo resist material.

As shown in the cross-sectional diagram of FIG. 3, the black matrix layer 21K is also created on the specific surface of the facing substrate 202. As described above, the specific surface of the facing substrate 202 is a surface exposed to the TFT array substrate 201. The black matrix layer 21K separates the red-color filter layer 21R, the green-color filter layer 21G and the blue-color filter layer 21B, which together from the color filter layer 21, from each other. For example, the black matrix layer 21K is created by making use of a metal-oxide film having the black color to serve as a layer for blocking light.

As shown in the cross-sectional diagram of FIG. 3, the flattening film 22 is created from an insulation material beneath the color filter layer 21 and the black matrix layer 21K to cover the color filter layer 21 and the black matrix layer 21K. As described before, the particular surface of the facing substrate 202 is a surface exposed to the TFT array substrate 201. The facing electrode 23 is the so-called transparent electrode which is for example created by making use of ITO. The facing electrode 23 faces a plurality of pixel electrodes 62 and serves as an electrode common to the pixel electrodes 62.

As shown in the cross-sectional diagram of FIG. 3, the pixel switching devices 31 are created on the particular surface of the TFT array substrate 201. As described before, the particular surface of the TFT array substrate 201 is a surface exposed to the facing substrate 202. Each of the pixel switching devices 31 is associated with one of the red-color filter layer 21R, the green-color filter layer 21G and the blue-color filter layer 21B, which form the color filter layer 21 of the pixel P.

FIG. 5 is a diagram showing an enlarged cross section of a pixel switching device 31 employed in the first embodiment of the present invention.

As shown in the cross-sectional diagram of FIG. 5, the pixel switching device 31 includes a gate electrode 45, a gate insulation film 46g and a semiconductor layer 48. The pixel switching device 31 is created as a bottom-gate-type TFT having an LDD (Lightly Doped Drain) structure.

To put it concretely, the gate electrode 45 of the pixel switching device 31 is created from for example a metallic material such as the molybdenum.

On the other hand, the gate insulation film 46g of the pixel switching device 31 is created from an insulation material such as a silicon-oxide film.

The semiconductor layer 48 of the pixel switching device 31 is created from for example low-temperature poly-silicon. In addition, on the semiconductor layer 48, a channel area 48C is created at a location corresponding to the gate electrode 45 whereas an electrode pair consisting of source-drain electrodes 48A and 48B is created on both sides of the channel area 48C as shown in the cross-sectional diagram of FIG. 5. The source electrode 48A includes a low-concentration impurity area 48AL whereas the drain electrode 48B includes a low-concentration impurity area 48BL. Forming a pair, the low-concentration impurity area 48AL and the low-concentration impurity area 48BL are placed on both sides of the channel area 48C. The source electrode 48A also includes a high-concentration impurity area 48AH whereas the drain electrode 48B includes a high-concentration impurity area 48BH. The concentration of impurities in each of the high-concentration impurity area 48AH and the high-concentration impurity area 48BH is higher than the concentration of impurities in each of the low-concentration impurity area 48AL and the low-concentration impurity area 48BL. Forming another pair, the high-concentration impurity area 48AH and the high-concentration impurity area 48BH are placed on both sides of the pair consisting of the low-concentration impurity area 48AL and the low-concentration impurity area 48BL.

In the pixel switching device 31, each of the source electrode 53 and the drain electrode 54 is created by making use of a conductive material such as the aluminum.

As shown in the cross-sectional diagram of FIG. 3, the flattening film 60 is created on the pixel switching devices 31 to cover the pixel switching devices 31. As described before, the particular surface of the TFT array substrate 201 is a surface exposed to the facing substrate 202. The pixel electrodes 62 are created on the flattening film 60. In this embodiment, as shown in the cross-sectional diagram of FIG. 3, the pixel electrodes 62 are separated away from each other by gaps so that the pixel electrodes 62 are provided at a plurality of locations facing respectively the red-color filter layer 21R, the green-color filter layer 21G and the blue-color filter layer 21B which together form the color filter layer 21. Provided in a state of being brought into contact with the liquid-crystal layer 203, each of the pixel electrodes 62 is connected to the drain electrode 54 of a pixel switching device 31 provided for the pixel electrode 62. For example, each of the pixel electrodes 62 is the so-called transparent electrode created by making use of ITO. In accordance with the electric potential of a video signal received from the pixel switching device 31, the pixel electrode 62 applies a voltage to the liquid-crystal layer 203 sandwiched by the pixel electrode 62 and the facing electrode 23.

In the sensor area RA, on the other hand, a light blocking section 21S and a photo sensor device 32a are created as shown in the cross-sectional diagram of FIG. 3 and the top-view diagram of FIG. 4. The photo sensor device 32a is configured to detect light coming from the front-surface side of the liquid-crystal panel 200.

As the black matrix layer 21K is created on the specific surface of the facing substrate 202 in the display area TA, the light blocking section 21S is created on the specific surface of the facing substrate 202. In the same way as the color filter layer 21, the black matrix layer 21K blocks light. The light blocking section 21S is provided with a light receiving area SA. The light coming from the front-surface side of the liquid-crystal panel 200 passes through the light receiving area SA. In the same way as the flattening film 22 in the display area TA, the flattening film 22 is also created beneath the light blocking section 21S on the specific surface of the facing substrate 202 to cover the light blocking section 21S whereas the facing electrode 23 is created below the flattening film 22.

Much like the pixel switching devices 31, the photo sensor device 32a is created on the particular surface of the TFT array substrate 201. As described before, the particular surface of the TFT array substrate 201 is a surface exposed to the facing substrate 202 as shown in the cross-sectional diagram of FIG. 3. As shown in the cross-sectional diagram of FIG. 3, the photo sensor device 32a is created at a location corresponding to the light receiving area SA. The photo sensor device 32a receives light arriving at the light receiving area SA and then propagating from the facing substrate 202 to the TFT array substrate 201 by way of the liquid-crystal layer 203. The photo sensor device 32a converts the received light coming from the light receiving area SA into an electrical signal representing received-light data. The received-light data is then read out. For example, the backlight 300 generates the illumination light beam R which is then reflected by the detection subject F, and the reflected light H which is reflected by the detection subject F propagates from the front-surface side to the rear surface of the liquid-crystal panel 200 as shown in the cross-sectional diagram of FIG. 1. In this case, the photo sensor device 32a receives the reflected light H and generates the received-light data. In this embodiment, as described above, the reflected light H is the illumination light beam R reflected by blood flowing in the detection subject F which is a biological object.

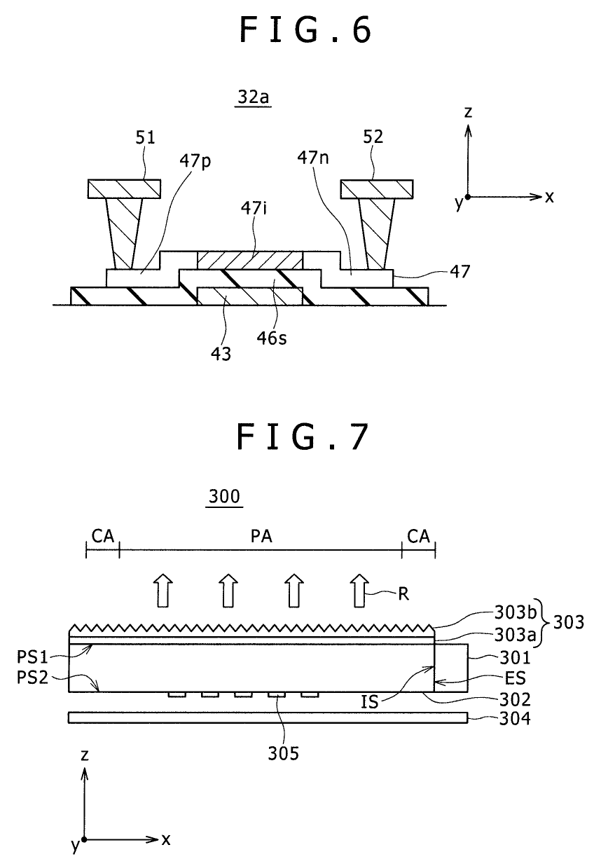

FIG. 6 is a diagram showing an enlarged cross section of the photo sensor device 32a employed in the first embodiment of the present invention.

As shown in the cross-sectional diagram of FIG. 6, the photo sensor device 32a is a photodiode with a PIN structure having a control electrode 43, a insulation film 46s, a semiconductor layer 47, a anode electrode 51 and a cathode electrode 52. The insulation film 46s is provided on the control electrode 43 whereas the semiconductor layer 47 is provided to face the control electrode 43, sandwiching the insulation film 46s in conjunction with the control electrode 43.

To put it concretely, in the photo sensor device 32a, the control electrode 43 is created from for example a metallic material such as the molybdenum whereas the insulation film 46s is created from an insulation material such as a silicon-oxide film and the semiconductor layer 47 is created from for example poly-silicon. The semiconductor layer 47 includes a p layer 47p, an n layer 47n and a high-resistance 47i which is placed between the p layer 47p and the n layer 47n. Each of the anode electrode 51 and the cathode electrode 52 is created by making use of a conductive material such as the aluminum.

### (Configuration of the Backlight)

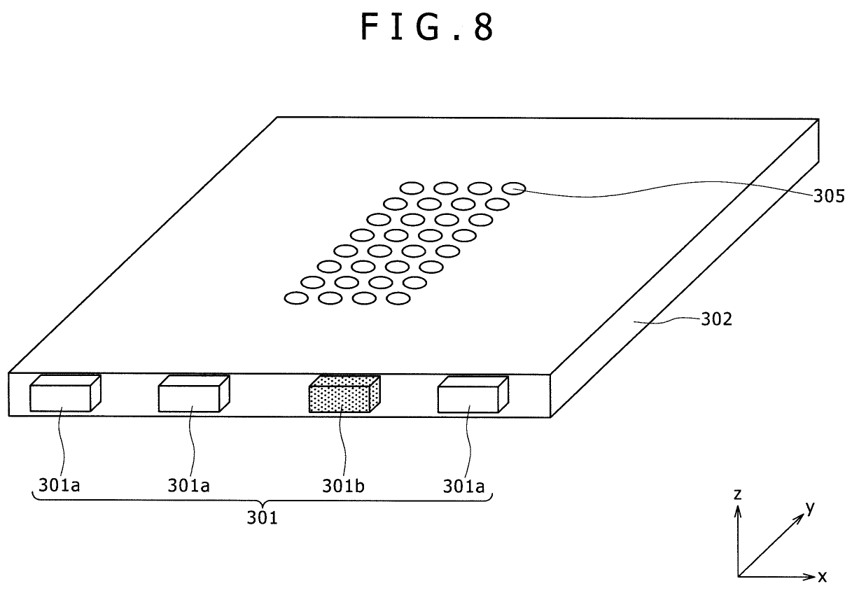

FIG. 7 is a cross-sectional diagram showing a model of the backlight 300 employed in the first embodiment of the present invention. FIG. 8 is a diagram showing a perspective view of the backlight 300 employed in the first embodiment of the present invention.

As shown in the cross-sectional diagram of FIG. 7, the backlight 300 has a light source 301 and a light guiding board 302. The backlight 300 radiates illumination light R to the entire pixel area PA of the liquid-crystal panel 200.

As shown in the cross-sectional diagram of FIG. 7, the light source 301 has an irradiation surface ES facing a light incidence surface IS of the light guiding board 302. In other words, the light incidence surface IS provided on a side of the light guiding board 302 is exposed to the irradiation surface ES of the light source 301. The irradiation surface ES generates light which is received by the light incidence surface IS for receiving the light generated by the light source 301. The light source 301 is configured to receive a control signal from the control section 401 and carry out an operation to generate light on the basis of the control signal.

As shown in the perspective-view diagram of FIG. 8, in this embodiment, the light source 301 has a visible light source 301a and an infrared light source 301b.

The visible light source 301a is for example a white-color LED configured to generate a visible light beam provided with the white color. As shown in the perspective-view diagram of FIG. 8, the visible light source 301a is provided in such a way that the irradiation surface ES of the visible light source 301a is exposed to the light incidence surface IS of the light guiding board 302 so that the visible light beam generated by the irradiation surface ES is radiated to the light incidence surface IS. In actuality, there are provided a plurality of such visible light sources 301a which are arranged over the light incidence surface IS of the light guiding board 302.

The infrared light source 301b is for example an infrared color LED configured to generate an infrared light beam. As shown in the perspective-view diagram of FIG. 8, the infrared light source 301b is provided in such a way that the irradiation surface ES of the infrared light source 301b is exposed to the light incidence surface IS of the light guiding board 302 so that the infrared light beam generated by the irradiation surface ES is radiated to the light incidence surface IS. For example, the infrared light source 301b generates an infrared light beam with a center wavelength of 850 nm. In a typical configuration of the embodiment, only one infrared light source 301b is provided to form an array in conjunction with the visible light sources 301a which are arranged over the light incidence surface IS of the light guiding board 302 as described above. In this embodiment, as shown in the perspective-view diagram of FIG. 8, the infrared light source 301b is provided at approximately the center of the light incidence surface IS over which the visible light sources 301a which are arranged.

As shown in the cross-sectional diagram of FIG. 7, the light guiding board 302 is provided in such a way that the light incidence surface IS of the light guiding board 302 is exposed to the irradiation surface ES of the light source 301. Thus, the light generated by the irradiation surface ES hits the light incidence surface IS. The light guiding board 302 guides the light hitting the light incidence surface IS to a radiation surface PS1 of the light guiding board 302 so that the light is generated from the radiation surface PS1 as the illumination light beam R mentioned before. The radiation surface PS1 is provided perpendicularly to the light incidence surface IS. The light guiding board 302 is provided on the rear-surface side of the liquid-crystal panel 200 to face the rear surface of the liquid-crystal panel 200. Thus, the illumination light beam R generated by the radiation surface PS1 is radiated to the rear surface of the liquid-crystal panel 200. Made of a transparent material having a high optical transmissivity, the light guiding board 302 is created to serve as a board having a radiation type. A typical example of the transparent material having a high optical transmissivity is the acryl resin.

To put it in detail, in this embodiment, the light guiding board 302 guides both the visible light beam generated by the visible light source 301a to hit the light incidence surface IS and the infrared light beam generated by the infrared light source 301b also to hit the light incidence surface IS. The guided visible light beam and the guided infrared light beam are radiated from the radiation surface PS1 to the liquid-crystal panel 200 as the illumination light beam R. As a result of the radiation of the visible light beam, an image is displayed in the pixel area PA of the liquid-crystal panel 200 of the transmission type as described before.

As shown in the cross-sectional diagram of FIG. 7, the light guiding board 302 is provided with an optical film 303, a light reflection film 304 and a plurality of infrared light beam reflection layers 305.

As shown in the cross-sectional diagram of FIG. 7, in the light guiding board 302, the optical film 303 is created on the radiation surface PS1. The optical film 303 is configured to receive the illumination light beam R radiated by the radiation surface PS1 of the light guiding board 302 and modulate the optical characteristic of the illumination light beam R.

In this embodiment, the optical film 303 has a light spreading sheet 303a and a prism sheet 303b. In the light guiding board 302, the light spreading sheet 303a is created on the radiation surface PS1 and the prism sheet 303b is created on the light spreading sheet 303a. In the light guiding board 302, the light spreading sheet 303a spreads the illumination light beam radiated by the radiation surface PS1 of the light guiding board 302 whereas the prism sheet 303b converges the illumination light beam, which has been spread by the light spreading sheet 303a, in a normal direction z perpendicular to the radiation surface PS1. Thus, the optical film 303 radiates the illumination light beam generated by the radiation surface PS1 of the light guiding board 302 to the rear surface of the liquid-crystal panel 200 as a planar illumination light beam R.

As shown in the cross-sectional diagram of FIG. 7, in the light guiding board 302, the light reflection film 304 is provided to face a bottom surface PS2 of the light guiding board 302. The bottom surface PS2 is a surface on a side opposite to the optical film 303 provided on the radiation surface PS1. In the light guiding board 302, the light reflection film 304 reflects some light radiated from the bottom surface PS2 to the radiation surface PS1.

As shown in the cross-sectional diagram of FIG. 7, in the light guiding board 302, the infrared light beam reflection layers 305 are provided beneath the bottom surface PS2 on the side opposite to the radiation surface PS1. The infrared light beam reflection layers 305 are configured to reflect only infrared light beams generated by the infrared light source 301b of the light source 301.

The infrared light beam reflection layers 305 reflect only the infrared light beams in a direction parallel to the direction from the rear-surface side of the liquid-crystal panel 200 to the front-surface side of the liquid-crystal panel 200. Provided at locations corresponding to the locations of the photo sensor devices 32a in the pixel area PA, the infrared light beam reflection layers 305 reflect only the infrared light beams to the radiation surface PS1 to be radiated from the radiation surface PS1 as the illumination light beam R.

As shown in the perspective-view diagram of FIG. 8, the infrared light beam reflection layers 305 are provided in the light guiding board 302 at locations separated away from each other in the surface direction to form a dot pattern. To put it concretely, as shown in the perspective-view diagram of FIG. 8, each of the infrared light beam reflection layers 305 has a circular shape and the infrared light beam reflection layers 305 are laid out in the x and y directions to form a matrix. The infrared light beam reflection layers 305 are provided at the center of the bottom surface PS2 of the light guiding board 302.

In this embodiment, each of the infrared light beam reflection layers 305 is created to include an infrared light beam reflection pigment for reflecting an infrared light beam. For example, the infrared light beam reflection layers 305 are created by carrying out a printing process to print printing liquid including infrared light beam reflection pigments and binder resin on locations on the bottom surface PS2 provided on the side opposite to the radiation surface PS1 in the light guiding board 302.

For example, the infrared light beam reflection pigment used in the infrared light beam reflection layer 305 is a product made by Kawamura Chemical Corporation as a product having a commercial name of AB820 Black.

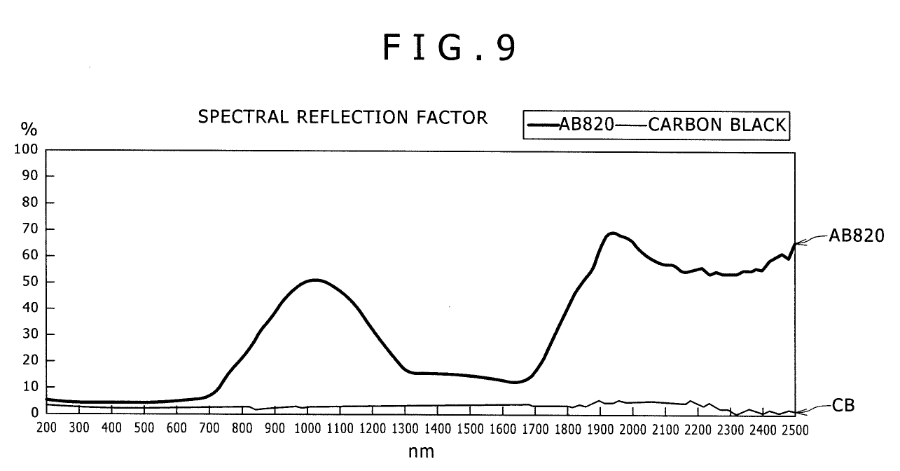

FIG. 9 is a diagram showing curves each representing a relation between the spectral reflection factor of the infrared light beam reflection pigment used in the infrared light beam reflection layer 305 in the first embodiment of the present invention and the wavelength of the light hitting the infrared light beam reflection layer 305. To be more specific, in the diagram of FIG. 9, the horizontal axis represents the wavelength (nm) of the light whereas the vertical axis represents the spectral reflection factor (%) at which the light is reflected by the infrared light beam reflection pigment. One of the curve represents a relation between the spectral reflection factor of ordinary carbon black CB serving as the infrared light beam reflection pigment and the wavelength of the light whereas the other curve represents a relation between the spectral reflection factor of AB820 Black made by Kawamura Chemical Corporation to serve as the infrared light beam reflection pigment and the wavelength of the light. It is to be noted that the diagram of FIG. 9 is a diagram quoted from “Infrared Light Reflection Pigment!! (Kawamura Chemical),” online information representing a result of a search operation carried out on Dec. 18, 2007 or from the Internet at a home-page address of http://www.sanyo-trading.co.jp/kagaku/pdf/4.pdf.

As shown in the diagram of FIG. 9, AB820 Black made by Kawamura Chemical Corporation to serve as the infrared light beam reflection pigment has a spectral reflection factor of 50% for an infrared light beam having a wavelength of 850 nm. On the other hand, AB820 Black serving as the infrared light beam reflection pigment has a spectral reflection factor not greater than 5% for a visible light beam. Thus, AB820 Black is capable of better reflecting an infrared light beam at a spectral reflection factor higher than the spectral reflection factor at which a visible light beam is reflected.

In addition, it is preferable to make use of resin capable of transmitting light as the binder resin for creating the infrared light beam reflection layer 305. Typical resin capable of transmitting light is the resin of the acryl group. For example, as the binder resin used for creating the infrared light beam reflection layer 305, it is possible to make use of the acryl resin MG10 made by Sumitomo Chemical Corporation. The infrared light beam reflection layers 305 are created by carrying out a printing process to print mixture liquid mixing infrared light beam reflection pigments with the binder resin. To put it concretely, the infrared light beam reflection pigments are mixed with the binder resin in the mixture liquid to be used as ink liquid at a pigment mixture concentration in the range 0.01 to 5% which are values each representing a ratio of the weight of the infrared light beam reflection pigments to the weight of the binding resin. After the pigment mixture concentration of the ink liquid is adjusted to a value in the range, dots of the ink liquid are printed on a light transmissible substrate by carrying out a screen printing process. For example, the area of the dot is set at a value in the range 10 to 500 μm². In addition, the density of the dots is set at such a design value that the uniformity and strength of infrared planar light sources on the upper surface of the backlight 300 are made optimal. The design value of the density of the dots is found by carrying out optical simulation.

In addition, it is desirable to set the thickness of the infrared light beam reflection layer 305 at a value at least equal to 0.8 μm.

It is to be noted that it is also desirable to provide visible-light reflection layers to serve as layers for reflecting only visible light beams as a plurality of dots in the same way as the infrared light beam reflection layers 305.

### (Operations)

The following description explains a biometric authentication process carried out by the liquid-crystal display apparatus 100 on the basis received-light data obtained by receiving light which is reflected by a detection subject F such as a finger of the user when the detection subject F is brought into contact with the pixel area PA of the liquid-crystal panel 200 or approaches the pixel area PA.

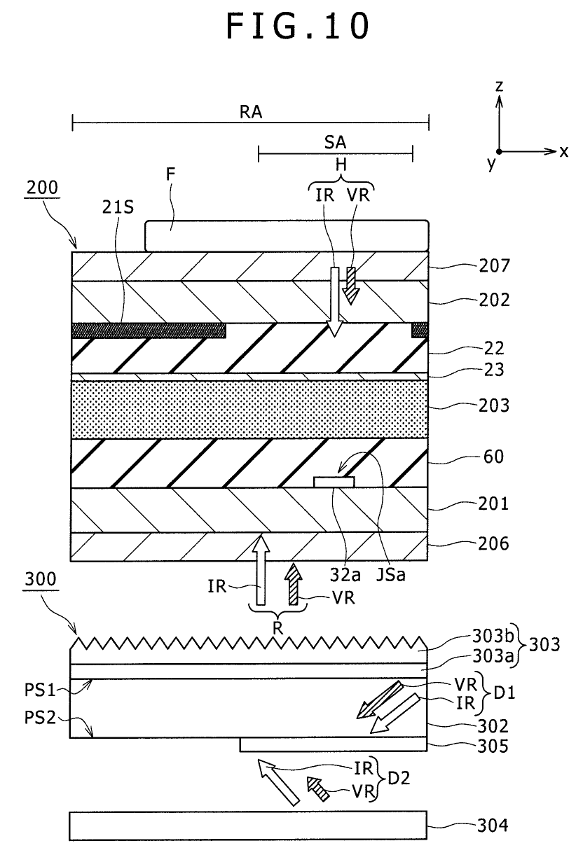

FIG. 10 is a cross-sectional diagram showing a model of a state of the liquid-crystal panel 200 and the backlight 300 during a biometric authentication process carried out by the liquid-crystal display apparatus 100 according to the first embodiment of the present invention on the basis received-light data obtained by receiving light which is reflected by a detection subject F such as a finger of the user when the detection subject F is brought into contact with the pixel area PA of the liquid-crystal panel 200 or approaches the pixel area PA. The cross-sectional diagram of FIG. 10 shows only components involved in the biometric authentication process and omits the other components.

When the detection subject F such a finger of the user is brought into contact with the pixel area PA of the liquid-crystal panel 200 or approaches the pixel area PA, as shown in the cross-sectional diagram of FIG. 10, the illumination light beam R generated by the backlight 300 is reflected by the detection subject F back to the photo sensor device 32a as the reflected light H. In the liquid-crystal panel 200, the reflected light H is received by the photo sensor device 32a.

To put it concretely, first of all, light D1 generated by the light source 301 in the backlight 300 is guided by the light guiding board 302 to the infrared light beam reflection layer 305 as shown in the cross-sectional diagram of FIG. 10.

In this embodiment, the light D1 generated by the light source 301 and guided by the light guiding board 302 include a visible light beam VR and an infrared light beam IR as described above.

The light D1 generated by the light source 301 propagates to the infrared light beam reflection layer 305 provided on the rear surface of the light guiding board 302.

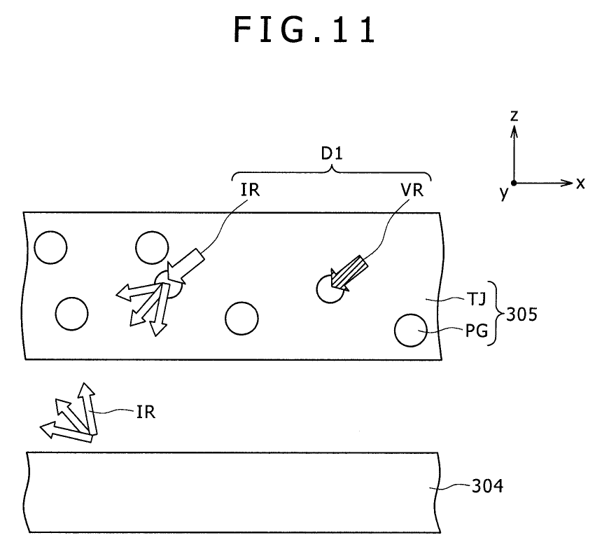

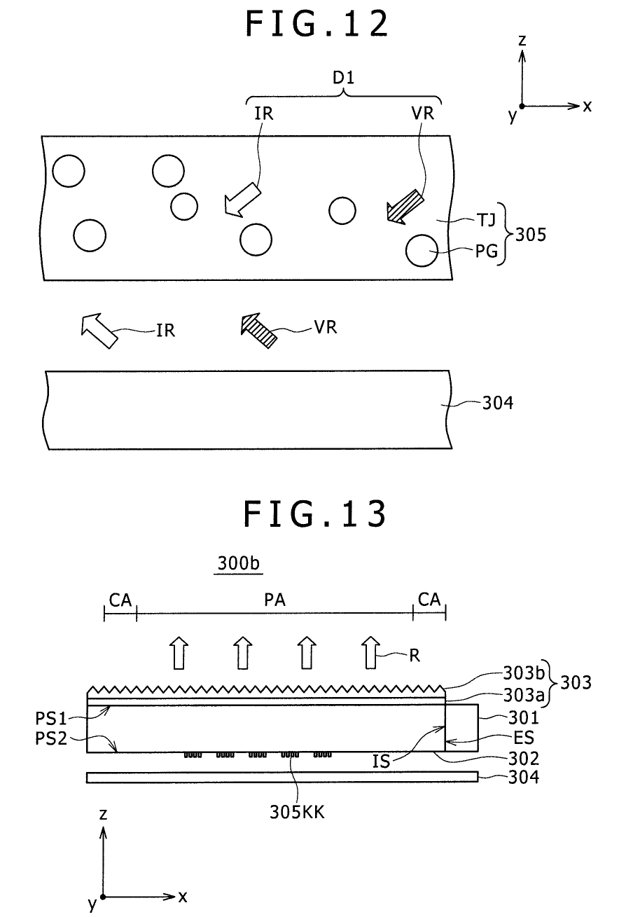

Each of FIGS. 11 and 12 is a side-view diagram conceptually showing a state in which the light D1 generated by the light source 301 is entering the infrared light beam reflection layer 305 in the first embodiment of the present invention. To be more specific, FIG. 11 is a side-view diagram conceptually showing a state in which the light D1 generated by the light source 301 hits an infrared-light-beam reflection pigment particle PG included in the infrared light beam reflection layer 305 in the first embodiment of the present invention. On the other hand, FIG. 12 is a side-view diagram conceptually showing a state in which the light D1 generated by the light source 301 does not hit an infrared-light-beam reflection pigment particle PG included in the infrared light beam reflection layer 305 in the first embodiment of the present invention.

As shown in the side-view diagram of FIG. 11, the infrared light beam reflection pigment particles PG are scattered in the transparent binder resin TJ of the infrared light beam reflection layer 305. Also as shown in the side-view diagram of FIG. 11, the light D1 including a visible light beam VR and an infrared light beam IR is entering the infrared light beam reflection layer 305.

If the visible light beam VR included in the light D1 hits an infrared-light-beam reflection pigment particle PG of the infrared light beam reflection layer 305, the visible light beam VR is not reflected by the infrared-light-beam reflection pigment particle PG. Instead, the visible light beam VR is absorbed by the infrared-light-beam reflection pigment particle PG.

If the infrared light beam IR included in the light D1 hits an infrared-light-beam reflection pigment particle PG of the infrared light beam reflection layer 305, the infrared light beam IR is reflected by the infrared-light-beam reflection pigment particle PG. In this case, the infrared light beam IR is reflected by the infrared-light-beam reflection pigment particle PG, being conceivably scattered in a variety of directions as shown in the side-view diagram of FIG. 11. Then, some of the infrared light beams IR scattered by the infrared-light-beam reflection pigment particle PG are reflected by a light reflecting surface of the light reflection film 304. In addition, some other infrared light beams IR scattered by the infrared-light-beam reflection pigment particle PG are conceivably reflected by a boundary surface of the infrared light beam reflection layer 305. These other scattered infrared light beams IR are not shown in the side-view diagram of FIG. 11 though.

As shown in the side-view diagram of FIG. 12, on the other hand, the light D1 does not hit an infrared-light-beam reflection pigment particle PG of the infrared light beam reflection layer 305. In this case, the light D1 passes through the transparent binder resin TJ of the infrared light beam reflection layer 305 and is reflected by the light reflecting surface of the light reflection film 304.

That is to say, the visible light beam VR included in the light D1 passes through the transparent binder resin TJ of the infrared light beam reflection layer 305 and is reflected by the light reflecting surface of the light reflection film 304. By the same token, the infrared light beam IR included in the light D1 passes through the transparent binder resin TJ of the infrared light beam reflection layer 305 and is reflected by the light reflecting surface of the light reflection film 304. In addition, some other infrared light beams IR included in the light D1 and some other visible light beams VR also included in the light D1 are conceivably reflected by the boundary surface of the infrared light beam reflection layer 305.

Since some visible light beams VR included in the light D1 generated by the light source 301 are absorbed by the light guiding board 302, the number of visible light beams VR included in the light D1 decreases as shown in the cross-sectional diagram of FIG. 10. As a result, more infrared light beams IR than visible light beams VR propagate to the rear surface of the liquid-crystal panel 200.

It is to be noted that an area for reflecting infrared light does not need to reflect visible light. In an area of dots for reflecting infrared light, however, it is necessary to separately print dots for reflecting visible light. The dots for reflecting visible light are shown in none of the figures. The layout of the dots for reflecting visible light is designed by setting each of the size of the dot and the density of such dots at such a design value according to the visible-light absorption characteristic exhibited by the infrared-light reflection material that the visible light is reflected uniformly in order to prevent the luminance of the visible light from decreasing.

The number of visible light beams VR included in the light D1 decreases to result in light D2 including more infrared light beams IR than visible light beams VR as shown in the cross-sectional diagram of FIG. 10. The light D2 is reflected by the light reflection film 304 and radiated from the radiation surface PS1 of the light guiding board 302 as light D2 including more infrared light beams IR than visible light beams VR. The light D2 radiated from the radiation surface PS1 of the light guiding board 302 arrives at the optical film 303. In the optical film 303, the light spreading sheet 303a spreads the light D2 radiated by the radiation surface PS1 of the light guiding board 302 whereas the prism sheet 303b converges the light D2, which has been spread by the light spreading sheet 303a, in a normal direction z perpendicular to the radiation surface PS1. Thus, the optical film 303 eventually radiates the light D2 generated by the radiation surface PS1 of the light guiding board 302 to the rear surface of the liquid-crystal panel 200 as a illumination light beam R.

The illumination light beam R generated by the backlight 300 passes through the liquid-crystal panel 200 and is then radiated to the detection subject F to be reflected by the detection subject F as reflected light H. As described above, since the infrared light beam reflection layer 305 reflects only infrared light beams IR, the illumination light beam R generated by the backlight 300 includes more infrared light beams IR than visible light beams VR. Thus, the reflected light H which is reflected by the detection subject F also includes more infrared light beams IR than visible light beams VR. In the case of this embodiment, a finger of a person is used as the detection subject F and blood flowing in a vein of the finger reflects the illumination light beam R, radiating the reflected light H as a result of the reflection to be used in a biometric authentication process which is based on many infrared light beams IR included in the reflected light H.

The reflected light H radiated by the detection subject F passes through the light receiving area SA provided in the sensor area RA of the liquid-crystal panel 200 and propagates to the light receiving surface JSa of the photo sensor device 32a located at a position corresponding to the position of the light receiving area SA. Then, the photo sensor device 32a receives the reflected light H arriving at the light receiving surface JSa.

The reflected light H directed to the light receiving surface JSa of the photo sensor device 32a and received by the photo sensor device 32a is subjected to a photo electrical conversion process of converting the reflected light H into an electrical signal having a strength according to the quantity of the reflected light H. The photo sensor device 32a thus generates an electrical signal with the strength thereof representing received-light data. Later on, a peripheral circuit reads out the received-light data.

Then, as described before, the biometric authentication section 402 makes use of the received-light data read out from the photo sensor device 32a to carry out an imaging process to create an image of the detection subject F positioned in the pixel area PA including a sensor area RA for every pixel P on the front-surface side of the liquid-crystal panel 200. Subsequently, the biometric authentication section 402 carries out a biometric authentication process on the image created as a result of the imaging process.

As described above, in this embodiment, the infrared light beam reflection layer 305 of the light guiding board 302 reflects the infrared light beam IR in a direction parallel to the direction from the rear-surface side of the liquid-crystal panel 200 to the front-surface side of the liquid-crystal panel 200. Each of the infrared light beam reflection layers 305 is provided at a position corresponding to a sensor area RA included in the pixel area PA as a sensor area in which one of a plurality of photo sensor devices 32a is created. Thus, illumination light beam R is radiated from the radiation surface PS1 of the light guiding board 302 as light including more infrared light beams IR reflected by the infrared light beam reflection layers 305 and the light reflection film 304 than visible light beams VR reflected only by the light reflection film 304. As a result, the photo sensor device 32a receives the reflected light H also including more infrared light beams IR than visible light beams VR because the reflected light H is no more than the illumination light beam R reflected by the detection subject F. The photo sensor device 32a then generates an electrical signal with the strength thereof representing received-light data from the reflected light H including more infrared light beams IR than visible light beams VR. Thus, this embodiment is capable of improving the S/N ratio of the received-light data. As a result, this embodiment is capable of carrying out a biometric authentication process based on infrared light beams IR with a high degree of precision.

If a biometric authentication process is carried out on the basis of received-light data generated from visible light beams VR included in the light H reflected by blood flowing in a finger used as the detection subject F, it is difficult to carry out the biometric authentication process with a high degree of precision in some cases. This is because the blood reflects the illumination light beam R including more infrared light beams IR than visible light beams VR as described above. In the case of this embodiment, however, the biometric authentication process is carried out on the basis of received-light data generated from infrared light beams IR included in the light H reflected by blood flowing in such a finger. Thus, the embodiment is capable of exhibiting the effect described above more remarkably than the effect of a case in which a biometric authentication process is carried out on the basis of received-light data generated from visible light beams VR included in the light H reflected by blood flowing in such a finger.

### Second Embodiment

Next, a second embodiment of the present invention is explained.

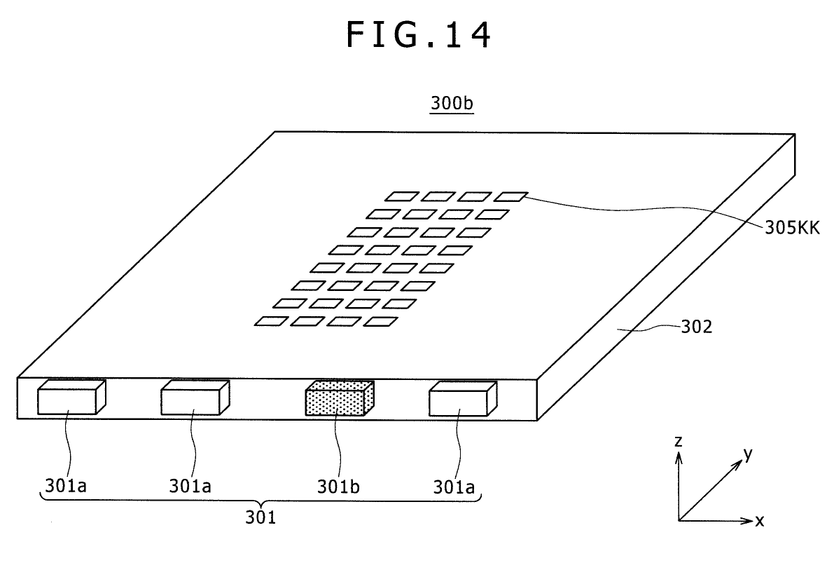

FIG. 13 is a cross-sectional diagram showing a model of a backlight 300b in a second embodiment of the present invention whereas FIG. 14 is a perspective-view diagram showing a model of the backlight 300b.

As is obvious from comparison of the cross-sectional diagram of FIG. 13 and the perspective-view diagram of FIG. 14 with respectively the cross-sectional diagram of FIG. 7 and the perspective-view diagram of FIG. 8 which are provided for the first embodiment, in the case of the second embodiment, diffraction lattice sections 305KK are used as a substitute for the infrared light beam reflection layers 305 employed in the first embodiment. Except for the use of the diffraction lattice sections 305KK as a substitute for the infrared light beam reflection layers 305, the second embodiment is basically identical with the first embodiment. For this reason, only the differences between the first and second embodiments are explained in order to avoid duplications of descriptions.

In the backlight 300b, the diffraction lattice sections 305KK are provided on the bottom surface PS2 on the side opposite to the radiation surface PS1 in the light guiding board 302 as shown in the cross-sectional diagram of FIG. 13. The diffraction lattice sections 305KK of the light guiding board 302 diffract light generated by the light source 301 and led to the light guiding board 302, guiding the diffracted light to the light reflection film 304. The light reflection film 304 then reflects the light diffracted and guided by the diffraction lattice sections 305KK of the light guiding board 302 to the liquid-crystal panel 200.

In this embodiment, each of the diffraction lattice sections 305KK is configured to radiate only an infrared light beam generated by the infrared light source 301b of the light source 301 to the light reflection film 304. Much like the infrared light beam reflection layers 305 employed in the first embodiment, each of the diffraction lattice sections 305KK is provided at a position corresponding to a sensor area RA included in the pixel area PA as a sensor area in which one of a plurality of photo sensor devices 32a is created.

A plurality of aforementioned diffraction lattice sections 305KK are provided as shown in the perspective-view diagram of FIG. 14. The diffraction lattice sections 305KK are provided in the light guiding board 302 at locations separated away from each other in the surface direction. To put it concretely, the diffraction lattice sections 305KK are laid out in the x and y directions to form a matrix as shown in the perspective-view diagram of FIG. 14. In this case, the diffraction lattice sections 305KK are placed at the center of the bottom surface PS2 in the light guiding board 302.

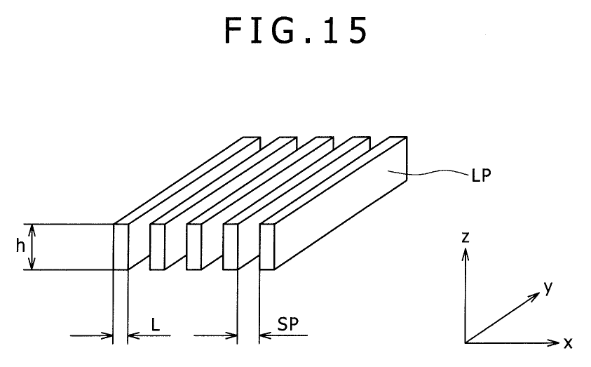

FIG. 15 is a diagram showing an enlarged perspective view of a diffraction lattice section 305KK in the second embodiment of the present invention.

As shown in the perspective-view diagram of FIG. 15, the diffraction lattice section 305KK is created as a lattice pattern including a plurality of line patterns LP each having a straight-line shape stretched in the y direction on the bottom surface PS2 of the light guiding board 302. In the lattice pattern, the line patterns LP of the diffraction lattice section 305KK are parallel to each other and arranged periodically in the x direction, being separated away from each other by a space SP.

In order for the light guiding board 302 to radiate only light having a specific wavelength to the light reflection film 304, the diffraction lattice section 305KK is created so that the pitch d of the lattice pattern satisfies a relation for example expressed by Eq. (1) given below. It is to be noted that, in Eq. (1), notation d denotes the pitch d of the lattice pattern, notation θ denotes the incidence angle of a light beam arriving at the diffraction lattice section 305KK and notation λ denotes the wavelength of the light beam.

2 d sin θ=λ (1)

For example, in this embodiment, the diffraction lattice section 305KK is created with the width L of the line pattern LP set at 0.4 μm, the width of the space SP between two line patterns LP adjacent to each other set at 0.6 μm and the h of the line pattern LP set at 1 μm.

For example, the diffraction lattice section 305KK is created on the bottom surface PS2 of the light guiding board 302 so as to integrate the diffraction lattice section 305KK with the light guiding board 302. To put it concretely, the diffraction lattice section 305KK is created on the bottom surface PS2 of the light guiding board 302 so as to integrate the diffraction lattice section 305KK with the light guiding board 302 by, first of all, injecting a creation material such as the acryl resin into a mold and, then, cooling the injected material in order to make the material hard.

The following description explains operations which are carried out in this second embodiment to implement the biometric authentication process on the basis of received-light data obtained from the reflected light H which is reflected by the detection subject F such a finger of the user when the detection subject F is brought into contact with the pixel area PA of the liquid-crystal panel 200 or approaches the pixel area PA.

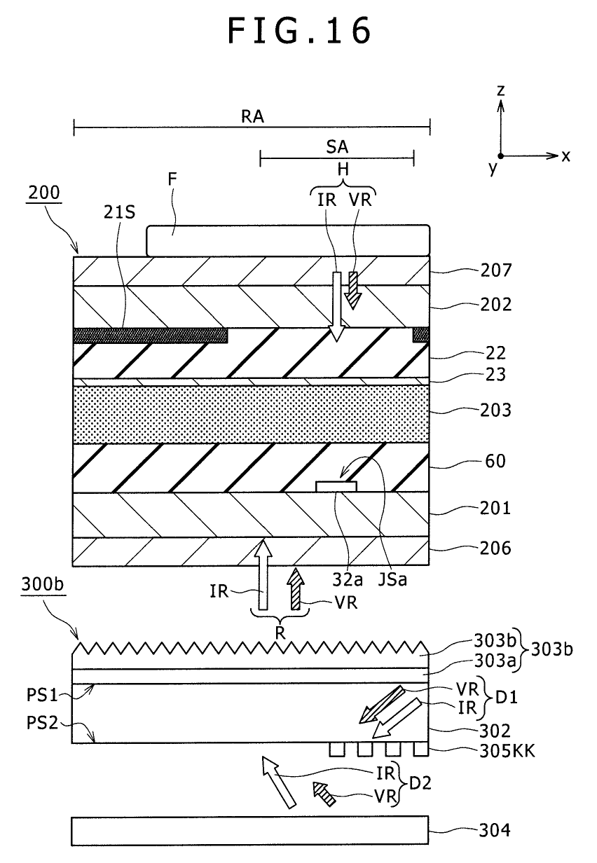

FIG. 16 is a cross-sectional diagram showing a model of a state of the liquid-crystal panel 200 and the backlight 300b during the biometric authentication process carried out by the liquid-crystal display apparatus 100b according to the second embodiment of the present invention on the basis of received-light data obtained from the reflected light H which is reflected by the detection subject F such a finger of the user when the detection subject F is brought into contact with the pixel area PA of the liquid-crystal panel 200 or approaches the pixel area PA. The cross-sectional diagram of FIG. 16 shows only components involved in the biometric authentication process and omits the other components.

When the detection subject F such a finger of the user is brought into contact with the pixel area PA of the liquid-crystal panel 200 or approaches the pixel area PA, as shown in the cross-sectional diagram of FIG. 16, the illumination light beam R generated by the backlight 300b is reflected by the detection subject F back to the photo sensor device 32a as the reflected light H. In the liquid-crystal panel 200, the reflected light H is received by the photo sensor device 32a.

To put it concretely, first of all, light D1 generated by the light source 301 in the backlight 300 is guided by the light guiding board 302 as shown in the cross-sectional diagram of FIG. 16.

The light D1 generated by the light source 301 include a visible light beam VR and an infrared light beam IR as described above.

The diffraction lattice section 305KK is configured to reflect only an infrared light beam IR. Thus, the infrared diffraction lattice section 305KK provided on the rear surface (that is, the bottom surface PS2) of the light guiding board 302 radiates only the infrared light beam IR, which is included in the D1 generated by the light source 301 and guided by the light guiding board 302 to hit the diffraction lattice section 305KK, to the light reflection film 304 as light D2.

The light D2 radiated by the diffraction lattice section 305KK is reflected by the light reflection film 304 to be radiated from the radiation surface PS1 of the light guiding board 302 to the optical film 303. In the optical film 303, the light spreading sheet 303a spreads the light D2 radiated by the diffraction lattice section 305KK, reflected by the light reflection film 304 and radiated from the radiation surface PS1 of the light guiding board 302, whereas the prism sheet 303b converges the light D2, which has been spread by the light guarding board 302, in a normal direction z perpendicular to the radiation surface PS1. Thus, the optical film 303 eventually radiates the illumination light D2 generated by the radiation surface PS1 of the light guiding board 302 to the rear surface of the liquid-crystal panel 200 as planar light R.

The illumination light beam R radiated by the prism sheet 303b of the backlight 300b passes through the liquid-crystal panel 200 and is then radiated to the detection subject F to be reflected by the detection subject F as reflected light H. As described above, since the diffraction lattice section 305KK reflects only infrared light beams IR, the illumination light beam R radiated by the prism sheet 303b of the backlight 300b includes more infrared light beams IR than visible light beams VR. Thus, the reflected light H which is reflected by the detection subject F also includes more infrared light beams IR than visible light beams VR. In the case of this second embodiment, in the same way as the first embodiment, a finger of a person is used as the detection subject F and blood flowing in a vein of the finger reflects the illumination light beam R, radiating the reflected light H as a result of the reflection to be used in a biometric authentication process based on many infrared light beams IR included in the reflected light H.

The reflected light H radiated by the detection subject F passes through the light receiving area SA provided in the sensor area RA of the liquid-crystal panel 200 and propagates to the light receiving surface JSa of the photo sensor device 32a located at a position corresponding to the position of the light receiving area SA. Then, the photo sensor device 32a receives the reflected light H arriving at the light receiving surface JSa.

The reflected light H directed to the light receiving surface JSa of the photo sensor device 32a and received by the photo sensor device 32a is subjected to a photo electrical conversion process of converting the reflected light H into an electrical signal having a strength according to the quantity of the reflected light H. The photo sensor device 32a generates the electrical signal having a strength representing received-light data. Later on, the data processing block 400 serving as a peripheral circuit reads out the received-light data from the photo sensor device 32a.

Then, as described before, the biometric authentication section 402 employed in the data processing block 400 makes use of the received-light data read out from the photo sensor device 32a to carry out an imaging process to create an image of the detection subject F positioned in the pixel area PA including a sensor area RA for every pixel P on the front-surface side of the liquid-crystal panel 200. Subsequently, the biometric authentication section 402 carries out a biometric authentication process on the image created as a result of the imaging process.

As described above, in this embodiment, the diffraction lattice section 305KK of the light guiding board 302 radiates only the infrared light beam IR to the light reflection film 304 which then reflects the radiated infrared light beam IR and a visible light beam VR in a direction parallel to the direction from the rear-surface side of the liquid-crystal panel 200 to the front-surface side of the liquid-crystal panel 200. Each of the diffraction lattice sections 305KK is provided at a position corresponding to a sensor area RA included in the pixel area PA as a sensor area in which one of a plurality of photo sensor devices 32a is created. Thus, illumination light beam R is radiated from the radiation surface PS1 of the light guiding board 302 as light including more infrared light beams IR reflected by the diffraction lattice sections 305KK and the light reflection film 304 than visible light beams VR reflected only by the light reflection film 304. As a result, the photo sensor device 32a receives the reflected light H also including more infrared light beams IR than visible light beams VR. The photo sensor device 32a then generates received-light data from the reflected light H including more infrared light beams IR than visible light beams VR. Thus, this embodiment is capable of improving the S/N ratio of the electrical signal with the strength thereof representing the received-light data. As a result, this embodiment is capable of carrying out a biometric authentication process based on infrared light beams IR with a high degree of precision.

### Third Embodiment

Next, a third embodiment of the present invention is explained.

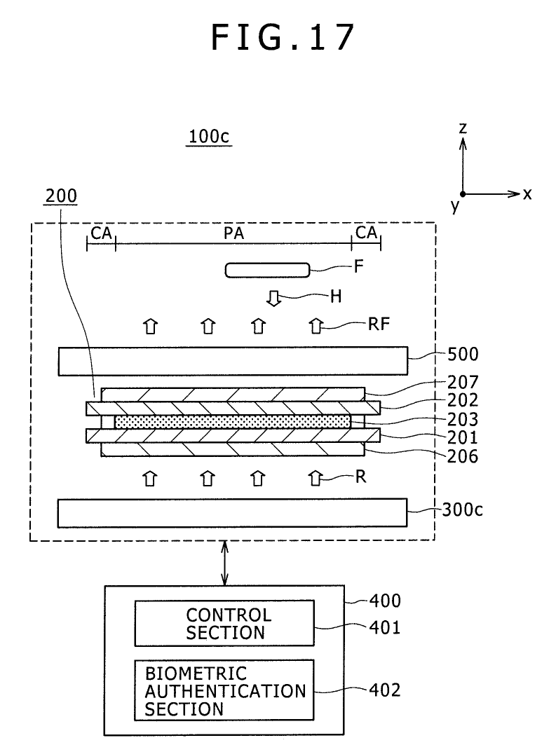

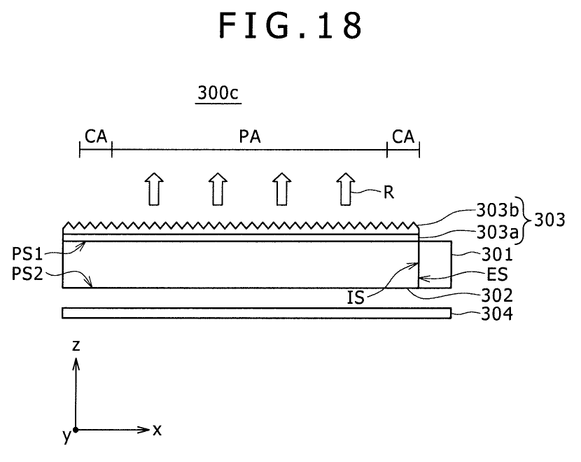

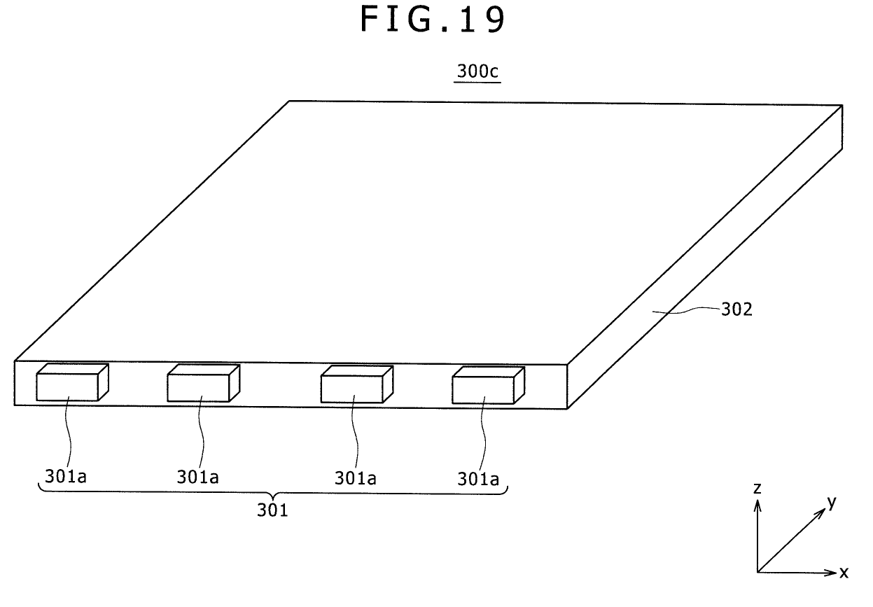

FIG. 17 is a diagram showing a cross section of the configuration of a liquid-crystal display apparatus 100c according to a third embodiment of the present invention. FIG. 18 is a cross-sectional diagram showing a model of a backlight 300c employed in the third embodiment of the present invention. FIG. 19 is a perspective-view diagram showing a model of main components composing the backlight 300c employed in the third embodiment of the present invention.

The third embodiment is different from the first one in that the third embodiment employs a front-light 500 as shown in the cross-sectional diagram of FIG. 17. In addition, as shown in the cross-sectional diagram of FIG. 18 and the perspective-view diagram of FIG. 19, the configuration of the backlight 300c employed in the third embodiment is different from the configuration of the backlight 300 employed in the first embodiment.

As shown in the cross-sectional diagram of FIG. 17, the liquid-crystal display apparatus 100c according to the third embodiment thus employs the front-light 500 in addition to the liquid-crystal panel 200, the backlight 300c and the data processing block 400.

As shown in the cross-sectional diagram of FIG. 17, the front-light 500 is provided to face the front surface of the liquid-crystal panel 200.

To put it concretely, the front-light 500 is provided outside the liquid-crystal panel 200 at a position closer to the facing substrate 202 employed in the liquid-crystal panel 200 than the TFT array substrate 201 also employed in the liquid-crystal panel 200. The front-light 500 generates illumination light RF from its surface on a side opposite to the side facing the liquid-crystal panel 200. That is to say, the front-light 500 generates illumination light RF in a direction parallel to the direction from the side of the TFT array substrate 201 to the side of the facing substrate 202. A direction parallel to a direction from the side of the TFT array substrate 201 to the side of the facing substrate 202 is referred to as a normal direction z perpendicular to the surfaces of the liquid-crystal panel 200.

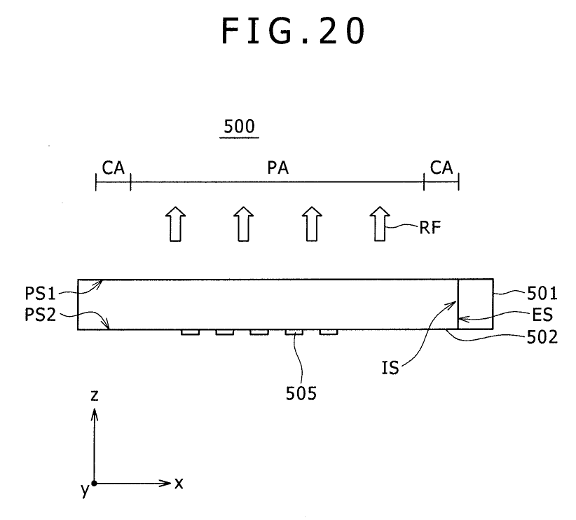

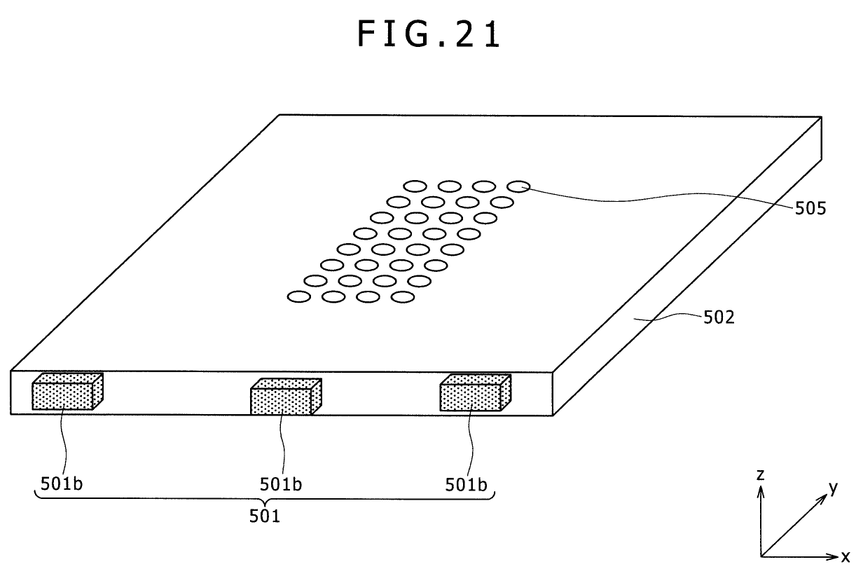

FIG. 20 is a cross-sectional diagram showing a model of the front-light 500 employed in the third embodiment of the present invention. FIG. 21 is a perspective-view diagram showing a model of main components composing the front-light 500 employed in the third embodiment of the present invention.

As shown in the cross-sectional diagram of FIG. 20, the front-light 500 employs a light source 501 and a light guiding board 502, radiating illumination light RF in a direction to a location corresponding to the pixel area PA of the liquid-crystal panel 200.

As shown in the cross-sectional diagram of FIG. 20, the light source 501 has an irradiation surface ES facing a light incidence surface IS of the light guiding board 502. In other words, the light incidence surface IS provided on a side of the light guiding board 502 is exposed to the irradiation surface ES of the light source 501. The light source 501 is configured to receive a control signal from the control section 401 and carry out an operation to generate light on the basis of the control signal.

As shown in the perspective-view diagram of FIG. 21, in this embodiment, the light source 501 has a plurality of infrared light sources 501b.

The infrared light source 501b is for example an infrared color LED configured to generate an infrared light beam. As shown in the perspective-view diagram of FIG. 21, the infrared light source 501b is provided in such a way that the irradiation surface ES of the infrared light source 501b is exposed to the light incidence surface IS of the light guiding board 502 so that the infrared light beam generated by the irradiation surface ES of is radiated to the light incidence surface IS. For example, the infrared light source 501b generates an infrared light beam with a center wavelength of 850 nm. In a typical configuration of the embodiment, a plurality of infrared light sources 501b are provided to form an array over the light incidence surface IS of the light guiding board 502 as shown in the perspective-view diagram of FIG. 21.

As shown in the cross-sectional diagram of FIG. 20, the light guiding board 502 is provided in such a way that the light incidence surface IS of the light guiding board 502 is exposed to the irradiation surface ES of the light source 501. Thus, the light generated by the irradiation surface ES hits the light incidence surface IS. The light guiding board 502 guides the light hitting the light incidence surface IS so that the light is generated from a radiation surface PS1 of the light guiding board 502 as the illumination light RF mentioned before. The radiation surface PS1 is provided perpendicularly to the light incidence surface IS. The light guiding board 502 is provided on the front-surface side of the liquid-crystal panel 200 to face the front surface of the liquid-crystal panel 200. The illumination light RF is generated by the radiation surface PS1 in a direction opposite to the direction toward the front-surface side of the liquid-crystal panel 200. Made of a transparent material having a high optical transmissivity, the light guiding board 502 is created to serve as a board having a radiation type. A typical example of the transparent material having a high optical transmissivity is the acryl resin.

In this embodiment, an infrared light beam generated by the infrared light source 501b hits the light incidence surface IS of the light guiding board 502 and the light guiding board 502 guides the light beam hitting the light incidence surface IS so that the light is generated from the radiation surface PS1 of the light guiding board 502 as the illumination light RF cited above.

As shown in the cross-sectional diagram of FIG. 20, the light guiding board 502 is provided with a plurality of infrared light beam reflection layers 505.

As shown in the cross-sectional diagram of FIG. 20, the light guiding board 502 has the infrared light beam reflection layers 505 provided on a bottom surface PS2 on a side opposite to the radiation surface PS1 in the light guiding board 502. Each of the infrared light beam reflection layers 505 is configured to reflect only an infrared light beam generated by the infrared light source 501b employed in the light source 501.

To put it in detail, each of the infrared light beam reflection layers 505 reflects only an infrared light beam generated by the infrared light source 501b employed in the light source 501 in a direction parallel to a direction from the rear-surface side of the liquid-crystal panel 200 to the front-surface side of the liquid-crystal panel 200. Provided at locations corresponding to the locations of the photo sensor devices 32a in the pixel area PA, the infrared light beam reflection layers 505 reflect only the infrared light beams to the radiation surface PS1 to be radiated from the radiation surface PS1 as the illumination light RF.

As shown in the perspective-view diagram of FIG. 21, the infrared light beam reflection layers 505 are provided in the light guiding board 502 at locations separated away from each other in the surface direction to form a dot pattern. To put it concretely, as shown in the perspective-view diagram of FIG. 21, each of the infrared light beam reflection layers 505 has a circular shape and the infrared light beam reflection layers 505 are laid out in the x and y directions to form a matrix. The infrared light beam reflection layers 505 are provided at the center of the bottom surface PS2 of the light guiding board 502 as the infrared light beam reflection layers 305 are provided at the center of the bottom surface PS2 of the light guiding board 302 of the backlight 300 in the first embodiment.

As shown in the cross-sectional diagram of FIG. 18, the backlight 300c has a light source 301 and a light guiding board 302. The backlight 300c radiates illumination light R to the entire pixel area PA of the liquid-crystal panel 200.

As shown in the cross-sectional diagram of FIG. 18, the light source 301 has an irradiation surface ES facing a light incidence surface IS of the light guiding board 302. In other words, the light incidence surface IS provided on a side of the light guiding board 302 is exposed to the irradiation surface ES of the light source 301. The irradiation surface ES generates light which is received by the light incidence surface IS for receiving the light generated by the light source 301. The light source 301 is configured to receive a control signal from the control section 401 and carry out an operation to generate light on the basis of the control signal.

In this embodiment, as shown in the perspective-view diagram of FIG. 19, the light source 301 has a visible light source 301a but, unlike the first embodiment, the light source 301 does not have an infrared light source 301b.

The visible light source 301a is for example a white-color LED configured to generate a visible light beam provided with the white color. As shown in the perspective-view diagram of FIG. 18, the visible light source 301a is provided in such a way that the irradiation surface ES of the visible light source 301a is exposed to the light incidence surface IS of the light guiding board 302 so that the visible light beam generated by the irradiation surface ES is radiated to the light incidence surface IS. In actuality, there are provided a plurality of such visible light sources 301a which are arranged over the light incidence surface IS of the light guiding board 302.

As shown in the cross-sectional diagram of FIG. 18, the light guiding board 302 is provided in such a way that the light incidence surface IS of the light guiding board 302 is exposed to the irradiation surface ES of the light source 301 in the same way as the first embodiment. Thus, the light generated by the irradiation surface ES hits the light incidence surface IS. The light guiding board 302 guides the light hitting the light incidence surface IS so that the light is generated from a radiation surface PS1 of the light guiding board 302 as the illumination light beam R mentioned before. The radiation surface PS1 is provided perpendicularly to the light incidence surface IS. The light guiding board 302 is provided on the rear-surface side of the liquid-crystal panel 200 to face the rear surface of the liquid-crystal panel 200. Thus, the illumination light beam R generated by the radiation surface PS1 is radiated to the rear surface of the liquid-crystal panel 200.

To put it in detail, in this embodiment, the light guiding board 302 guides the visible light beam generated by the visible light source 301a to hit the light incidence surface IS. The guided visible light beam is radiated from the radiation surface PS1 to the liquid-crystal panel 200 as the illumination light beam R. As a result, an image is displayed in the pixel area PA of the liquid-crystal panel 200 of the transmission type as described before.

As shown in the cross-sectional diagram of FIG. 18, the light guiding board 302 employs an optical film 303 and a light reflection film 304 but, unlike the first embodiment, the light guiding board 302 does not have the infrared light beam reflection layers 305.

As shown in the cross-sectional diagram of FIG. 18, in the light guiding board 302, the optical film 303 is created on the radiation surface PS1 in the same way as the first embodiment. In this embodiment, the optical film 303 has a light spreading sheet 303a and a prism sheet 303b. In the light guiding board 302, the light spreading sheet 303a is created on the radiation surface PS1 and the prism sheet 303b is created on the light spreading sheet 303a. In the light guiding board 302, the light spreading sheet 303a spreads the light radiated by the radiation surface PS1 of the light guiding board 302 whereas the prism sheet 303b converges the spread light in a normal direction z perpendicular to the radiation surface PS1. Thus, the optical film 303 radiates the light generated by the radiation surface PS1 of the light guiding board 302 to the rear surface of the liquid-crystal panel 200 as planar illumination light R.

As shown in the cross-sectional diagram of FIG. 18, in the light guiding board 302, the light reflection film 304 is provided to face a bottom surface PS2 on a side opposite to the optical film 303 provided on the radiation surface PS1. In the light guiding board 302, the light reflection film 304 reflects some light radiated from the bottom surface PS2 provided on a side opposite to the radiation surface PS1 to the radiation surface PS1.

The following description explains a biometric authentication process carried out by the liquid-crystal display apparatus 100c on the basis received-light data obtained by receiving light which is reflected by a detection subject F such as a finger of the user when the detection subject F is brought into contact with the pixel area PA of the liquid-crystal panel 200 or approaches the pixel area PA.

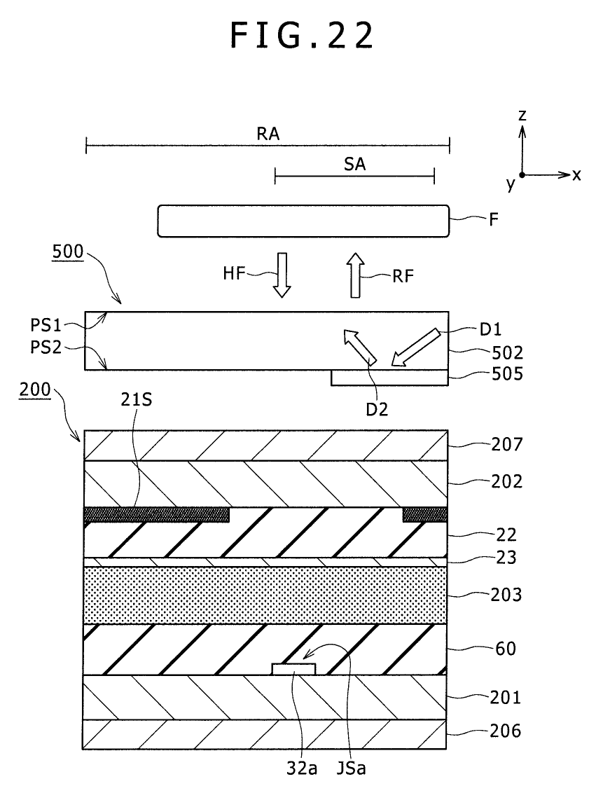

FIG. 22 is a cross-sectional diagram showing a model of a state of the liquid-crystal panel 200 during a biometric authentication process carried out by the liquid-crystal display apparatus 100c according to the third embodiment of the present invention on the basis received-light data obtained by receiving light which is reflected by a detection subject F such as a finger of the user when the detection subject F is brought into contact with the pixel area PA of the liquid-crystal panel 200 or approaches the pixel area PA. The cross-sectional diagram of FIG. 22 shows only components involved in the biometric authentication process and omits the other components.

When the detection subject F such a finger of the user is brought into contact with the pixel area PA of the liquid-crystal panel 200 or approaches the pixel area PA, as shown in the cross-sectional diagram of FIG. 22, the illumination light RF generated by the front-light 500 is reflected by the detection subject F back to the photo sensor device 32a as the reflected light HF. In the liquid-crystal panel 200, the reflected light HF is received by the photo sensor device 32a.

To put it concretely, first of all, light D1 generated by the light source 501 is guided by the light guiding board 502 as shown in the cross-sectional diagram of FIG. 22.

In this embodiment, the light D1 generated by the light source 501 and guided by the light guiding board 502 includes an infrared light beam IR as described above.

The infrared light beam reflection layer 505 is configured to reflect only an infrared light beam IR rather than reflecting a visible light beam VR. Thus, an infrared light beam IR included in the light D1 generated by the light source 501 and guided by the light guiding board 502 to hit the infrared light beam reflection layer 505 provided on the rear surface of the light guiding board 502 is selectively reflected by the infrared light beam reflection layer 505 to the radiation surface PS1 of the light guiding board 502. That is to say, the infrared light beam reflection layer 505 reflects only an infrared light beam IR included in the light D1 to the radiation surface PS1 of the light guiding board 502.

The light D2 reflected by the infrared light beam reflection layer 505 to the radiation surface PS1 of the light guiding board 502 is radiated from the radiation surface PS1 as the illumination light RF.

The illumination light RF generated by the front-light 500 is radiated to the detection subject F to be reflected by the detection subject F as reflected light HF. As described above, since the infrared light beam reflection layer 505 reflects only infrared light beams IR, the illumination light RF generated by the front-light 500 includes mainly infrared light beams IR. Thus, the reflected light HF reflected by the detection subject F also includes mainly infrared light beams IR. In the case of this embodiment, a finger of a person is used as the detection subject F and blood flowing in a vein of the finger reflects the illumination light RF, radiating the reflected light HF as a result of the reflection to be used in a biometric authentication process based on many infrared light beams IR included in the reflected light HF.

The reflected light HF radiated by the detection subject F passes through the light receiving area SA provided in the sensor area RA of the liquid-crystal panel 200 and propagates to the light receiving surface JSa of the photo sensor device 32a located at a position corresponding to the position of the light receiving area SA. Then, the photo sensor device 32a receives the reflected light HF arriving at the light receiving surface JSa. As shown in the cross-sectional diagram of FIG. 22, the photo sensor device 32a located at a position corresponding to the position of the light receiving area SA receives the reflected light HF coming from the detection subject F through a portion included in the front-light 500 as a portion with no infrared light beam reflection layer 505.

The reflected light HF directed to the light receiving surface JSa of the photo sensor device 32a and received by the photo sensor device 32a is subjected to a photo electrical conversion process of converting the reflected light HF into an electrical signal having a strength according to the quantity of the reflected light HF. The photo sensor device 32a generates the electrical signal with the strength thereof representing received-light data. Later on, the a peripheral circuit reads out the received-light data.

Then, as described before, the biometric authentication section 402 makes use of the received-light data read out from the photo sensor device 32a to carry out an imaging process to create an image of the detection subject F positioned in the pixel area PA on the front-surface side of the liquid-crystal panel 200. Subsequently, the biometric authentication section 402 carries out a biometric authentication process on the image created as a result of the imaging process.

As described above, in this embodiment, the infrared light beam reflection layer 505 of the light guiding board 502 reflects the infrared light beam IR in a direction parallel to the direction from the rear-surface side of the liquid-crystal panel 200 to the front-surface side of the liquid-crystal panel 200. Each of the infrared light beam reflection layers 505 is provided at a position corresponding to a sensor area RA included in the pixel area PA as a sensor area in which one of a plurality of photo sensor devices 32a is created. Thus, illumination light RF is radiated from the radiation surface PS1 of the light guiding board 502 as light including mainly infrared light beams IR reflected by the infrared light beam reflection layers 505. As a result, the photo sensor device 32a receives the reflected light HF also including mainly infrared light beams IR. The photo sensor device 32a then generates received-light data from the reflected light HF including many infrared light beams IR. Thus, in the same way as the first embodiment, the third embodiment is capable of improving the S/N ratio of an electrical signal with the strength thereof representing the received-light data. As a result, this embodiment is capable of carrying out a biometric authentication process based on infrared light beams IR with a high degree of precision.

### Fourth Embodiment

Next, a fourth embodiment of the present invention is explained.

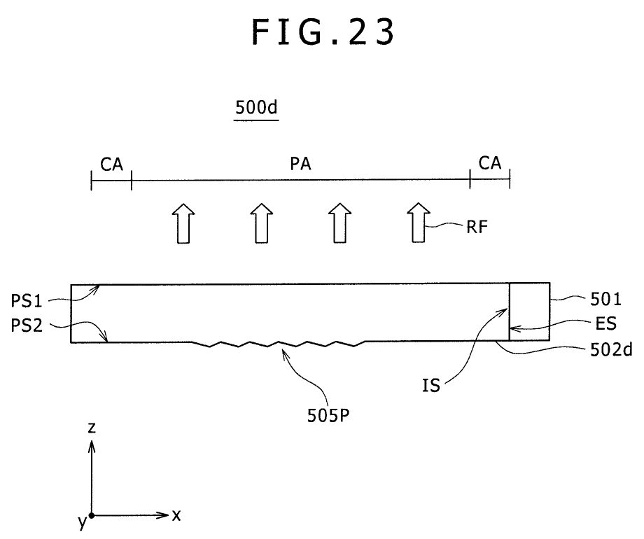

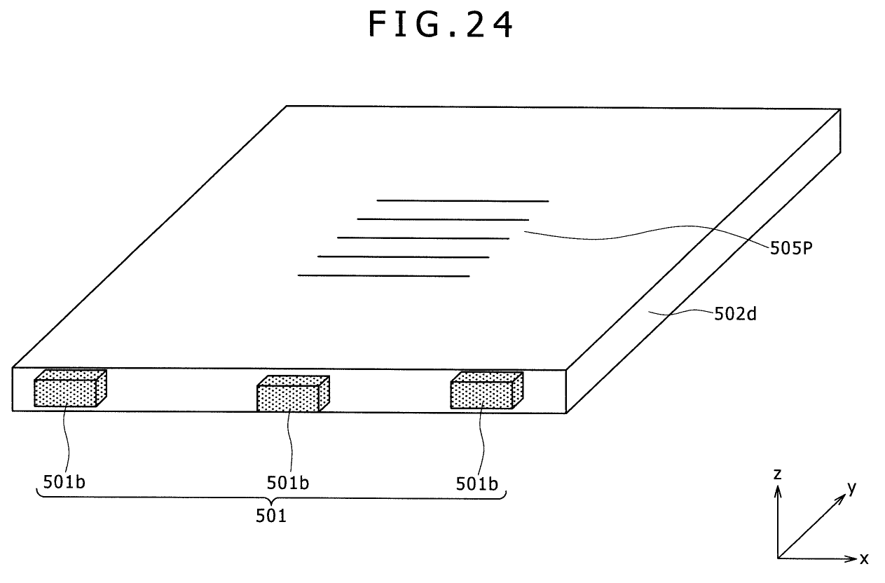

FIG. 23 is a cross-sectional diagram showing a model of a front-light 500d employed in a fourth embodiment of the present invention. FIG. 24 is a perspective-view diagram showing a model of main components composing the front-light 500d employed in the fourth embodiment of the present invention.

As shown in the cross-sectional diagram of FIG. 23 and the perspective-view diagram of FIG. 24, the configuration of the light guiding board 502d employed in the front-light 500d of the fourth embodiment is different from the configuration of the light guiding board 502 employed in the front-light 500 of the third embodiment. Except for this difference, the fourth embodiment is basically identical with the third embodiment. For this reason, only the differences between the fourth and third embodiments are explained in order to avoid duplications of descriptions.

As shown in the cross-sectional diagram of FIG. 23 and the perspective-view diagram of FIG. 24, as a substitute for the infrared light beam reflection layer 505 of the third embodiment, the light guiding board 502d in the fourth embodiment is provided with a prism surface 505P to serve as an infrared light beam reflection section.

As shown in the cross-sectional diagram of FIG. 23, in the light guiding board 502d, the prism surface 505P is provided on the bottom surface PS2 on a side opposite to the radiation surface PS1. The prism surface 505P reflects only an infrared light beam generated by the infrared light source 501b of the light source 501.

The prism surface 505P is created by adjusting the angle of inclined surfaces of the prism surface 505P so that the prism surface 505P reflects an infrared light beam in a direction parallel to the direction from the rear-surface side of the liquid-crystal panel 200 to the front-surface side of the liquid-crystal panel 200. To put it concretely, the angle of the inclined surfaces of the prism surface 505P is adjusted in accordance with the incidence angle of the infrared light beam arriving at the light guiding board 502d. For example, in a process of creating the light guiding board 502d, the prism surface 505P is also created so as to provide the light guiding board 502d with the prism surface 505P. Each of the prism surfaces 505P is provided at a position corresponding to a sensor area RA included in the pixel area PA as a sensor area in which one of a plurality of photo sensor devices 32a is created. The prism surface 505P reflects an infrared light beam and the reflected infrared light beam is radiated by the radiation surface PS1 as illumination light RF.

As shown in the cross-sectional diagram of FIG. 23 and the perspective-view diagram of FIG. 24, a plurality of such prism surfaces 505P are provided on the light guiding board 502d. The prism surfaces 505P are provided at the center of the bottom surface PS2 of the light guiding board 502.

The following description explains a biometric authentication process on the basis received-light data obtained by receiving light which is reflected by a detection subject F such as a finger of the user when the detection subject F is brought into contact with the pixel area PA of the liquid-crystal panel 200 or approaches the pixel area PA.

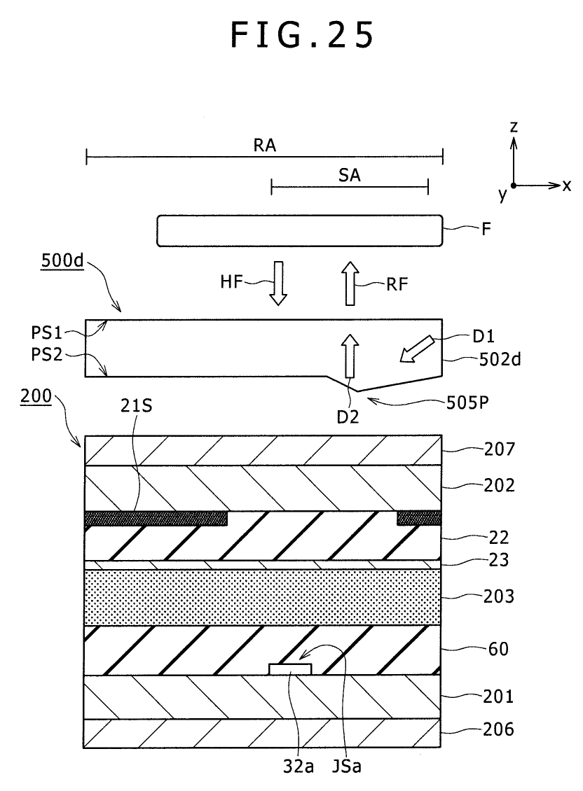

FIG. 25 is a cross-sectional diagram showing a model of a state of the liquid-crystal panel 200 and the front-light 500d during a biometric authentication process carried out by the liquid-crystal display apparatus 100d according to the fourth embodiment of the present invention on the basis received-light data obtained by receiving light which is reflected by a detection subject F such as a finger of the user when the detection subject F is brought into contact with the pixel area PA of the liquid-crystal panel 200 or approaches the pixel area PA. The cross-sectional diagram of FIG. 25 shows only components involved in the biometric authentication process and omits the other components.

When the detection subject F such a finger of the user is brought into contact with the pixel area PA of the liquid-crystal panel 200 or approaches the pixel area PA, as shown in the cross-sectional diagram of FIG. 25, in the same way as the third embodiment, the illumination light RF generated by the front-light 500d is reflected by the detection subject F back to the photo sensor device 32a as the reflected light HF. In the liquid-crystal panel 200, the reflected light HF is received by the photo sensor device 32a.

To put it concretely, first of all, light D1 generated by the light source 501 in the front-light 500d is guided by the light guiding board 502d to propagate to the prism surface 505P as shown in the cross-sectional diagram of FIG. 25. In the fourth embodiment, the light D1 generated by the light source 501 and guided by the light guiding board 502d includes an infrared light beam IR as described above. The prism surface 505P is configured to reflect only an infrared light beam IR rather than reflecting a visible light beam VR in a normal direction z perpendicular to the bottom surface PS2 in which the prism surface 505P is provided. Thus, an infrared light beam IR included in the D1 generated by the light source 501 and guided by the light guiding board 502 to hit the prism surface 505P provided on the bottom surface PS2 serving as the rear surface of the light guiding board 502 is selectively reflected by the prism surface 505P to the radiation surface PS1 of the light guiding board 502. That is to say, the prism surface 505P reflects only an infrared light beam IR included in the light D1 to the radiation surface PS1 of the light guiding board 502. Then, light D2 reflected by the infrared light beam reflection layer 505 to the radiation surface PS1 of the light guiding board 502 is radiated from the radiation surface PS1 as the illumination light RF.

The illumination light RF generated by the front-light 500d is radiated to the detection subject F to be reflected by the detection subject F as reflected light HF in the same way as the first embodiment. The reflected light HF radiated by the detection subject F passes through the light receiving area SA provided in the sensor area RA of the liquid-crystal panel 200 and propagates to the light receiving surface JSa of the photo sensor device 32a located at a position corresponding to the position of the light receiving area SA. Then, the photo sensor device 32a receives the reflected light HF arriving at the light receiving surface JSa.

The reflected light HF directed to the light receiving surface JSa of the photo sensor device 32a and received by the photo sensor device 32a is subjected to a photo electrical conversion process of converting the reflected light HF into an electrical signal having a strength according to the quantity of the reflected light HF. The photo sensor device 32a generates the electrical signal with the strength thereof representing received-light data. Later on, a peripheral circuit reads out the received-light data.

Then, in the same way as the first embodiment described before, the biometric authentication section 402 employed in the data processing block 400 makes use of the received-light data read out from the photo sensor device 32a to carry out an imaging process to create an image of the detection subject F positioned in the pixel area PA including a sensor area RA for every pixel P on the front-surface side of the liquid-crystal panel 200. Subsequently, the biometric authentication section 402 carries out a biometric authentication process on the image created as a result of the imaging process.

As described above, in the fourth embodiment, the prism surface 505P of the light guiding board 502d reflects the infrared light beam IR in a direction parallel to the direction from the rear-surface side of the liquid-crystal panel 200 to the front-surface side of the liquid-crystal panel 200. Each of the prism surfaces 505P is provided at a position corresponding to a sensor area RA included in the pixel area PA as a sensor area in which one of a plurality of photo sensor devices 32a is created. The illumination light RF is radiated from the radiation surface PS1 of the light guiding board 502 as light including mainly infrared light beams IR reflected by the prism surfaces 505P. Thus, the photo sensor device 32a receives the reflected light HF also including mainly infrared light beams IR. The photo sensor device 32a then generates received-light data from the reflected light HF including many infrared light beams IR. Thus, the fourth embodiment is capable of improving the S/N ratio of an electrical signal with the strength thereof representing the received-light data in the same way as the third embodiment. As a result, much like the third embodiment, the fourth embodiment is capable of carrying out a biometric authentication process based on infrared light beams IR with a high degree of precision.

### Fifth Embodiment

Next, a fifth embodiment of the present invention is explained.

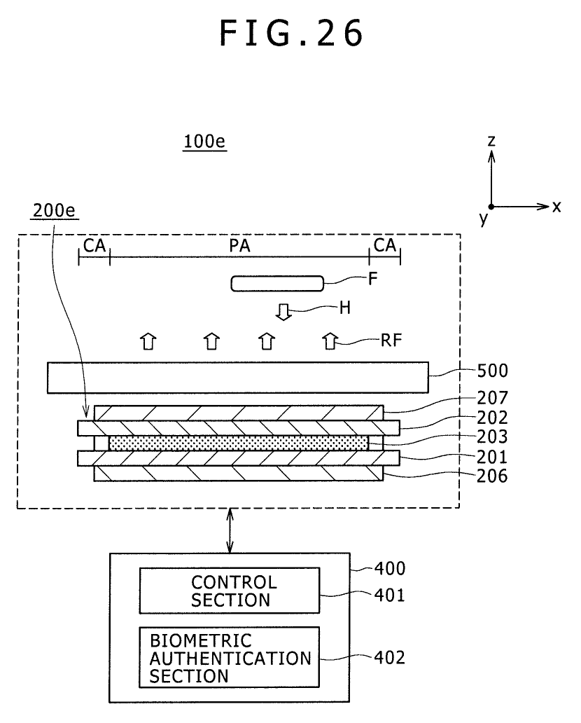

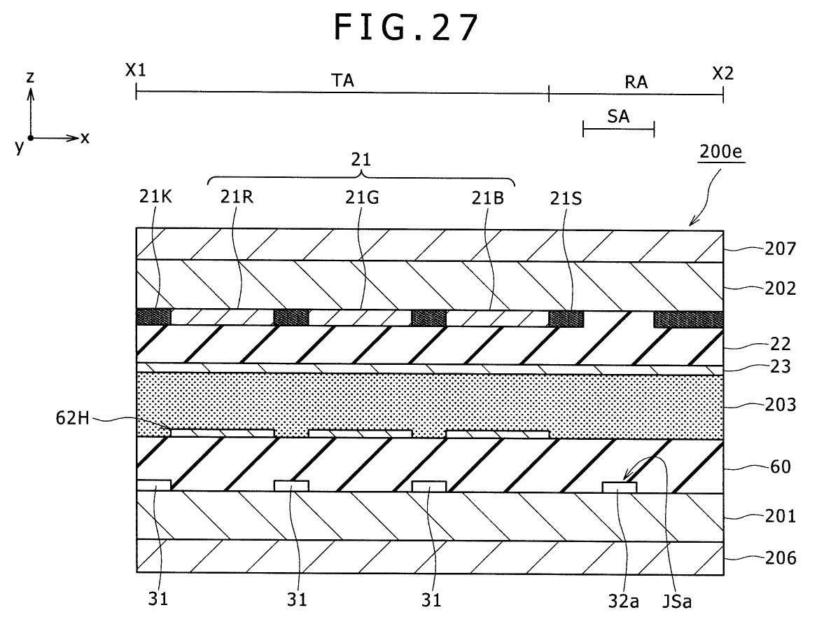

FIG. 26 is a diagram showing a cross section of the configuration of a liquid-crystal display apparatus 100e according to a fifth embodiment of the present invention. FIG. 27 is a cross-sectional diagram showing an approximate model of the pixel P provided in the pixel area PA of a liquid-crystal panel 200e employed in the fifth embodiment of the present invention. Much like the cross-sectional diagram of FIG. 3, the cross-sectional diagram of FIG. 27 shows a cross section at a location indicated by a dashed line denoted by notations X1 and X2 shown in the top-view diagram of FIG. 4.

As is obvious from comparison of the diagram of FIG. 26 showing a cross section of the configuration of the liquid-crystal display apparatus 100e according to the fifth embodiment with the diagram of FIG. 17 showing a cross section of the configuration of the liquid-crystal display apparatus 100c according to the third embodiment, the liquid-crystal display apparatus 100e is different from the liquid-crystal display apparatus 100c in that the liquid-crystal display apparatus 100e does not have a backlight 300c. In addition, as is obvious from comparison of the diagram of FIG. 27 showing a cross section of the configuration of the liquid-crystal panel 200e according to the fifth embodiment with the diagram of FIG. 3 showing a cross section of the configuration of the liquid-crystal panel 200 according to the third embodiment, the liquid-crystal panel 200e is different from the liquid-crystal panel 200 in that the liquid-crystal panel 200e employs the pixel electrodes 62 employed in the liquid-crystal panel 200. Except for these differences, the fifth embodiment is basically identical with the third embodiment. For this reason, only the differences between the fifth and third embodiments are explained in order to avoid duplications of descriptions.

As shown in the cross-sectional diagram of FIG. 26, the liquid-crystal display apparatus 100e according to the fifth embodiment employs the liquid-crystal panel 200e, a data processing block 400 and a front-light 500 but does not have a backlight 300. The configurations of the data processing block 400 and the front-light 500 are identical with those employed in the third embodiment.

The pixel electrode 62H employed in the liquid-crystal panel 200e is not a transmission-type electrode for passing through light like the pixel electrode 62 employed in the third embodiment, but a reflection-type electrode for reflecting light. The pixel electrode 62H is created by for example making use of silver. That is to say, the liquid-crystal panel 200e is not a panel of the transmission type, but a panel of the reflection type. In the liquid-crystal panel 200e of the reflection type, the pixel electrode 62H of the reflection type is configured to reflect light entering the liquid-crystal panel 200e from the front-surface side in order to display an image. Except for the difference between the pixel electrode 62H employed in the liquid-crystal panel 200e and the pixel electrode 62 employed in the liquid-crystal panel 200, the configuration of the liquid-crystal panel 200e is identical with the configuration of the liquid-crystal panel 200.

A biometric authentication process carried out by the liquid-crystal display apparatus 100e on the basis received-light data obtained by receiving light which is reflected by a detection subject F such as a finger of the user when the detection subject F is brought into contact with the pixel area PA of the liquid-crystal panel 200e or approaches the pixel area PA is identical with the biometric authentication process according to the third embodiment.

That is to say, as shown in the cross-sectional diagram of FIG. 22, in the front-light 500, light D1 generated by the light source 501 and guided by the light guiding board 502 to hit the infrared light beam reflection layer 505 provided on the bottom surface PS2 serving as the rear surface of the light guiding board 502 is selectively reflected by the infrared light beam reflection layer 505 to the radiation surface PS1 of the light guiding board 502. That is to say, the infrared light beam reflection layer 505 reflects only an infrared light beam IR included in the light D1 to the radiation surface PS1 of the light guiding board 502. Then, light D2 reflected by the infrared light beam reflection layer 505 to the radiation surface PS1 of the light guiding board 502 is radiated from the radiation surface PS1 as the illumination light RF.

The illumination light RF generated by the front-light 500 is radiated to the detection subject F to be reflected by the detection subject F as reflected light HF. As described above, since the infrared light beam reflection layer 505 reflects only infrared light beams IR, the illumination light RF generated by the front-light 500 includes mainly infrared light beams IR. Thus, the reflected light HF reflected by the detection subject F also includes mainly infrared light beams IR. In the case of the fifth embodiment, a finger of a person is used as the detection subject F and blood flowing in a vein of the finger reflects the illumination light RF, radiating the reflected light HF as a result of the reflection to be used in a biometric authentication process based on many infrared light beams IR included in the reflected light HF.

The reflected light HF radiated by the detection subject F passes through the light receiving area SA provided in the sensor area RA of the liquid-crystal panel 200e and propagates to the light receiving surface JSa of the photo sensor device 32a located at a position corresponding to the position of the light receiving area SA. Then, the photo sensor device 32a receives the reflected light HF arriving at the light receiving surface JSa.

The reflected light HF directed to the light receiving surface JSa of the photo sensor device 32a and received by the photo sensor device 32a is subjected to a photo electrical conversion process of converting the reflected light HF into an electrical signal having a strength according to the quantity of the reflected light HF. The photo sensor device 32a generates the electrical signal with the strength thereof representing received-light data. Later on, a peripheral circuit reads out the received-light data.

Then, in the same way as the third embodiment described before, the biometric authentication section 402 employed in the data processing block 400 makes use of the received-light data read out from the photo sensor device 32a to carry out an imaging process to create an image of the detection subject F positioned in the pixel area PA on the front-surface side of the liquid-crystal panel 200e. Subsequently, the biometric authentication section 402 carries out a biometric authentication process on the image created as a result of the imaging process.

As described above, in the same way as the third embodiment, in the fifth embodiment, the photo sensor device 32a employed in the liquid-crystal panel 200e receives the reflected light HF also including mainly infrared light beams IR. The photo sensor device 32a then generates received-light data from the reflected light HF including many infrared light beams IR. Thus, the fifth embodiment is capable of improving the S/N ratio of an electrical signal with the strength thereof representing the received-light data in the same way as the third embodiment. As a result, much like the third embodiment, the fifth embodiment is capable of carrying out a biometric authentication process based on infrared light beams IR with a high degree of precision.

### Sixth Embodiment

Next, a sixth embodiment of the present invention is explained.

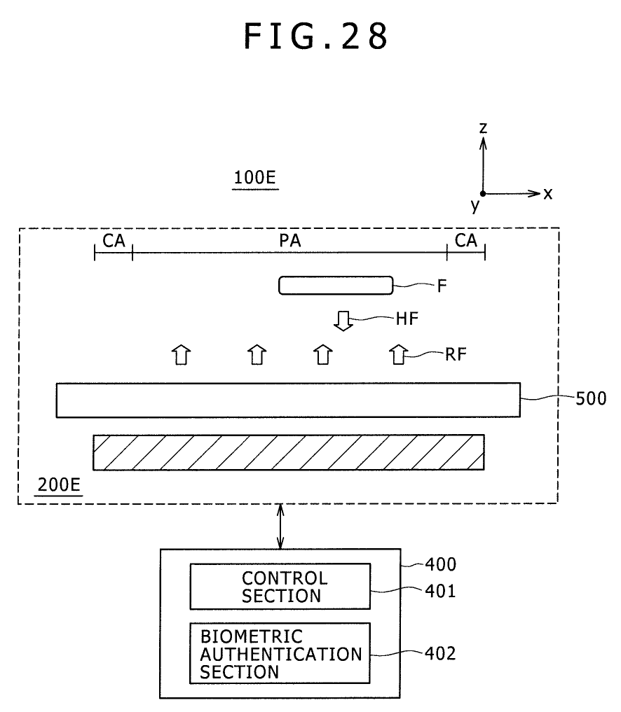

FIG. 28 is a diagram showing a cross section of the configuration of an EL display apparatus 100E according to a sixth embodiment of the present invention.

As shown in the cross-sectional diagram of FIG. 28, however, the sixth embodiment employs an EL panel 200E as a substitute for the liquid-crystal panel 200e of the fifth embodiment described so far. That is to say, the sixth embodiment is basically similar to the fifth embodiment except that the sixth embodiment employs the EL panel 200E in place of the liquid-crystal panel 200e.

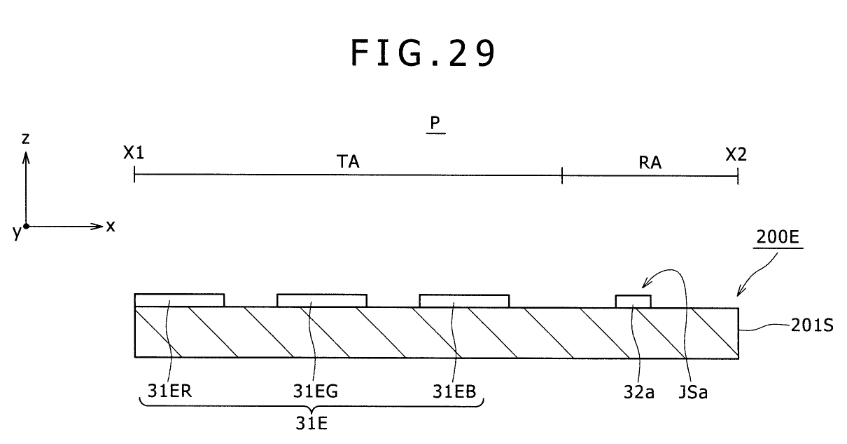

FIG. 29 is a cross-sectional diagram showing a model of one of a plurality of pixels P located in the pixel area PA of the EL panel 200E employed in the sixth embodiment of the present invention.

As shown in the cross-sectional diagram of FIG. 29, the EL panel 200E has a substrate 201S. On the surface of the substrate 201S, a plurality of electric-field light emitting devices 31E and a photo sensor device 32a are created. In the same way as the liquid-crystal panel 200 described above, the pixels P are laid out in the pixel area PA to form a matrix. The electric-field light emitting devices 31E and a photo sensor device 32a are created to form one pixel P. The electric-field light emitting devices 31E in the EL panel 200E are driven by adoption of an active matrix driving technique to display an image on the EL panel 200E. In addition, in the same way as the other embodiments, the photo sensor device 32a in the EL panel 200E is driven to receive light and generate received-light data on the basis of the light.

The substrate 201S of the EL panel 200E is for example made of an insulation material such as the glass.

The electric-field light emitting devices 31E in a pixel P are created in the display area TA. The electric-field light emitting devices 31E emit light to display an image. The electric-field light emitting devices 31E is created by sequentially piling up components not shown in the cross-sectional diagram of FIG. 29 on the substrate 201S. The components sequentially piled up on the substrate 201S are for example a cathode, an electron injection layer, an electron transport layer, a light emitting layer, a hole transport layer, a hole injection layer and an anode. By applying a voltage between the cathode and the anode, the light emitting layer of the electric-field light emitting device 31E can be driven to emit light. To put it concretely, in the configuration of the electric-field light emitting device 31E, by applying a voltage between the cathode and the anode, holes and electrons are recombined with each other in the light emitting layer, generating an energy which excites the light emitting material of the light emitting layer. When the excited state is again restored to a base state, the light emitting layer emits light.

In the sixth embodiment, the field-effect light emitting device 31E includes a red-color field-effect light emitting device 31ER, a green-color field-effect light emitting device 31EG and a blue-color field-effect light emitting device 31EB as shown in the cross-sectional diagram of FIG. 29. The red-color field-effect light emitting device 31ER emits light of the red color, the green-color field-effect light emitting device 31EG emits light of the green color and the blue-color field-effect light emitting device 31EB emits light of the blue color.

As shown in the cross-sectional diagram of FIG. 29, the photo sensor device 32a is provided in the sensor area RA associated with the photo sensor device 32a in the same way as the other embodiments described so far. The photo sensor device 32a receives light located on the front-surface side of the EL panel 200E and generates received-light data representing the received light.

A biometric authentication process carried out by the EL display apparatus 100E on the basis received-light data obtained by receiving light which is reflected by the detection subject F such as a finger of the user when the detection subject F is brought into contact with the pixel area PA of the EL panel 200E or approaches the pixel area PA is identical with the biometric authentication process according to the third embodiment.

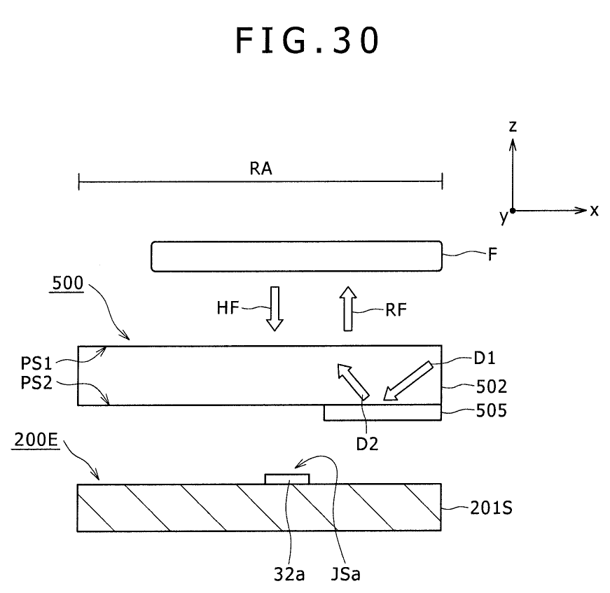

FIG. 30 is a cross-sectional diagram showing a model of a state of the EL panel 200E during a biometric authentication process carried out by the EL display apparatus 100E according to the sixth embodiment of the present invention on the basis received-light data obtained by receiving light which is reflected by a detection subject F such as a finger of the user when the detection subject F is brought into contact with the pixel area PA of the liquid-crystal panel 200E or approaches the pixel area PA. The cross-sectional diagram of FIG. 30 shows only components involved in the biometric authentication process and omits the other components.

As shown in the cross-sectional diagram of FIG. 30, in the front-light 500, light D1 generated by the light source 501 and guided by the light guiding board 502 to hit the infrared light beam reflection layer 505 is selectively reflected by the infrared light beam reflection layer 505. The infrared light beam reflection layer 505 reflects only an infrared light beam IR included in the light D1. Then, light D2 reflected by the infrared light beam reflection layer 505 to the radiation surface PS1 of the light guiding board 502 is radiated as the illumination light RF.

The illumination light RF generated by the front-light 500 is radiated to the detection subject F to be reflected by the detection subject F. As described above, since the infrared light beam reflection layer 505 reflects only infrared light beams IR, the illumination light RF generated by the front-light 500 includes mainly infrared light beams IR. Thus, the reflected light HF reflected by the detection subject F also includes mainly infrared light beams IR. In the case of the sixth embodiment, a finger of a person is used as the detection subject F and blood flowing in a vein of the finger reflects the illumination light RF.

The reflected light HF radiated by the detection subject F propagates to the light receiving surface JSa of the photo sensor device 32a in the sensor area RA of the EL panel 200E. Then, the photo sensor device 32a receives the reflected light HF arriving at the light receiving surface JSa.

The reflected light HF is subjected to a photo electrical conversion process of converting the reflected light HF into an electrical signal having a strength according to the quantity of the reflected light HF. The photo sensor device 32a generates the electrical signal with the strength thereof representing received-light data. Later on, the data processing block 400 serving as a peripheral circuit reads out the received-light data from the photo sensor device 32a.

Then, in the same way as the third embodiment described before, the biometric authentication section 402 makes use of the received-light data read out from the photo sensor device 32a to carry out an imaging process to create an image of the detection subject F positioned in the pixel area PA on the front-surface side of the EL panel 200E. Subsequently, the biometric authentication section 402 carries out a biometric authentication process on the image created as a result of the imaging process.

As described above, in the same way as the third embodiment, in the sixth embodiment, the photo sensor device 32a employed in the EL panel 200E receives the reflected light HF also including mainly infrared light beams IR because the reflected light HF is no more than the illumination light RF reflected by the detection subject F. The photo sensor device 32a then generates received-light data from the reflected light HF. Thus, the sixth embodiment is capable of improving the S/N ratio of an electrical signal with the strength thereof representing the received-light data in the same way as the third embodiment. As a result, much like the third embodiment, the sixth embodiment is capable of carrying out a biometric authentication process with a high degree of precision.

It is to be noted that the scope of the present invention is by no means limited to the embodiments described above. That is to say, the embodiments can be changed to result in a variety of modified versions.

For example, in the embodiments described above, a thin-film transistor of the bottom-gate type is employed as the pixel switching device 31. However, the pixel switching device 31 does not have to be a thin-film transistor of the bottom-gate type.

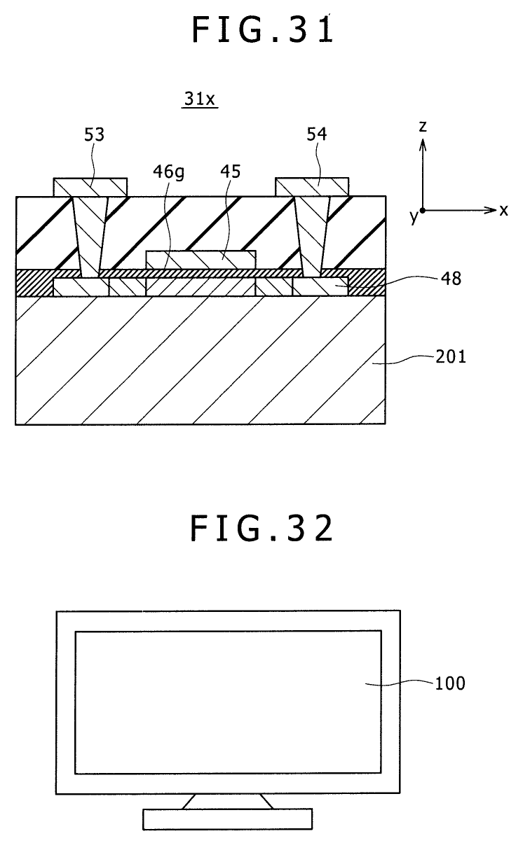

FIG. 31 is a cross-sectional diagram showing a modified version of the configuration of a pixel switching device 31x according to another embodiment of the present invention.

As shown in the cross-sectional diagram of FIG. 31, the pixel switching device 31x is a thin-film transistor of the top-gate type. As another modified version of the embodiments, the photo sensor device 32a can also be created to have a dual-gate structure.

In addition, in the embodiments described above, a plurality of photo sensor devices 32a are provided to correspond to the same plurality of pixels P respectively. However, the scope of the present invention is by no means limited to this scheme. For example, one photo sensor device 32a can also be provided to correspond to a plurality of pixels P or, conversely, a plurality of photo sensor devices 32a can also be provided to correspond to one pixel P. On top of that, it is also possible to provide a configuration in which a plurality of photo sensor devices 32a are provided to correspond to the same plurality of pixels P respectively in a partial area of the pixel area PA.

In addition, in the embodiments described above, the received-light data generated by the photo sensor device 32a is used in the execution of a biometric authentication process. However, the scope of the present invention is by no means limited to this scheme. For example, the received-light data generated by the photo sensor device 32a can also be used in the execution of a process to determine the position of a detection subject F. On top of that, the received-light data generated by the photo sensor device 32a can be used in a variety of applications.

In addition, in the embodiments described above, a photodiode of the PIN type is used as the photo sensor device 32a. However, the scope of the present invention is by no means limited to this scheme. For example, as the photo sensor device 32a, it is also possible to make use of a photodiode having a PDN structure in which an i layer is doped with impurities. Even if a photodiode having a PDN structure is used, it is possible to obtain the same effects as the photodiode of the PIN type. On top of that, a photo transistor can be provided as a photo sensor device 32a.

On top of that, in the embodiments described above, the red-color filter layer 21R, the green-color filter layer 21G and the blue-color filter layer 21B are each created to have a strip shape and arranged in the horizontal direction x. In the same array of the red-color filter layer 21R, the green-color filter layer 21G and the blue-color filter layer 21B, the light receiving area SA is created at a location adjacent to the red-color filter layer 21R. However, the scope of the present invention is by no means limited to this scheme. For example, it is also possible to provide a configuration in which the red-color filter layer 21R, the green-color filter layer 21G, the blue-color filter layer 21B and the light receiving area SA are combined in a set, being arranged to form a matrix consisting or two rows and two columns.

In addition, in the embodiments described above, illumination light including an infrared light beam as an invisible light beam is radiated. However, the scope of the present invention is by no means limited to this scheme. For example, the illumination light may also an ultraviolet light beam as an invisible light beam.

On top of that, it should be understood by those skilled in the art that a variety of modifications, combinations, sub-combinations and alterations may occur, depending on design requirements and other factors as far as they are within the scope of the appended claims or the equivalents thereof.

In addition, the display apparatus such as the liquid-crystal display apparatus 100, 100b, 100c, 100d or 100e according to the embodiments of the present invention can each be used as a display unit of a variety of electronic instruments.

Each of FIGS. 32 to 36 is a diagram showing an electronic instrument to which a liquid-crystal display apparatus 100, 100b, 100c, 100d or 100e according to the embodiments of the present invention is employed as a display unit.

FIG. 32 is a diagram showing a TV set employing a liquid-crystal display apparatus 100, 100b, 100c, 100d or 100e as a display unit for displaying images of TV broadcasts received by the TV set on the display screen of the TV set and for receiving as well as interpreting an operation instruction entered by the operator to the display screen. In addition, the liquid-crystal display apparatus 100, 100b, 100c, 100d or 100e is also capable of generating received-light data from light reflected by a detection subject F to the liquid-crystal display apparatus 100, 100b, 100c, 100d or 100e as data to be used in a biometric authentication process.

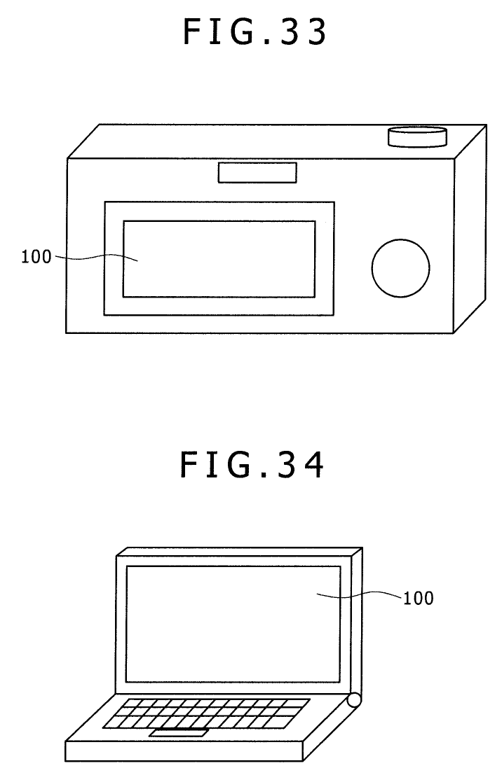

FIG. 33 is a diagram showing a digital still camera employing a liquid-crystal display apparatus 100, 100b, 100c, 100d or 100e as a display unit for displaying images of photographing subjects or the like on the display screen of the digital still camera and for receiving as well as interpreting an operation instruction entered by the operator to the display screen. In addition, the liquid-crystal display apparatus 100, 100b, 100c, 100d or 100e is also capable of generating received-light data from light reflected by a detection subject F to the liquid-crystal display apparatus 100, 100b, 100c, 100d or 100e as data to be used in a biometric authentication process.

FIG. 34 is a diagram showing a notebook personal computer employing a liquid-crystal display apparatus 100, 100b, 100c, 100d or 100e as a display unit for displaying operation images and the like on the display screen of the notebook personal computer and for receiving as well as interpreting an operation instruction entered by the operator to the display screen. In addition, the liquid-crystal display apparatus 100, 100b, 100c, 100d or 100e is also capable of generating received-light data from light reflected by a detection subject F to the liquid-crystal display apparatus 100, 100b, 100c, 100d or 100e as data to be used in a biometric authentication process.

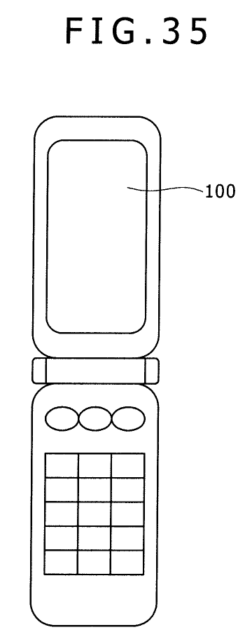

FIG. 35 is a diagram showing a cellular phone employing a liquid-crystal display apparatus 100, 100b, 100c, 100d or 100e as a display unit for displaying operation images and the like on the display screen of the cellular phone and for receiving as well as interpreting an operation instruction entered by the operator to the display screen. In addition, the liquid-crystal display apparatus 100, 100b, 100c, 100d or 100e is also capable of generating received-light data from light reflected by a detection subject F to the liquid-crystal display apparatus 100, 100b, 100c, 100d or 100e as data to be used in a biometric authentication process.

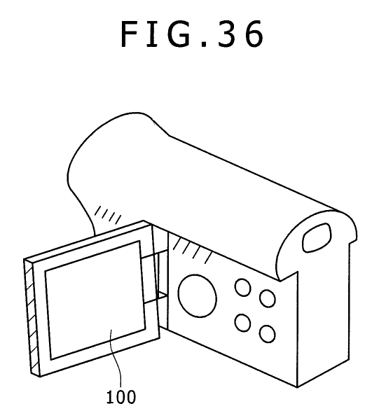

FIG. 36 is a diagram showing a video camera employing a liquid-crystal display apparatus 100, 100b, 100c, 100d or 100e as a display unit for displaying operation images and the like on the display screen of the video camera and for receiving as well as interpreting an operation instruction entered by the operator to the display screen. In addition, the liquid-crystal display apparatus 100, 100b, 100c, 100d or 100e is also capable of generating received-light data from light reflected by a detection subject F to the liquid-crystal display apparatus 100, 100b, 100c, 100d or 100e as data to be used in a biometric authentication process.

On top of that, the display apparatus such as the EL display apparatus 100E according to the sixth embodiment of the present invention can be used as a display unit of a variety of electronic instruments in the same way as the liquid-crystal display apparatus 100, 100b, 100c, 100d or 100e.

In addition, it is possible to apply the present invention to liquid-crystal display panels adopting a variety of methods such as IPS (In-Plane-Switching) and FFS (Field Fringe Switching) methods. On top of that, the display apparatus according to the present invention can be used as other display units such as an electronic-paper unit.

It is to be noted that each of the liquid-crystal display apparatus 100, 100b, 100c, 100d and 100e employed in the embodiments described above corresponds to a display apparatus provided by an embodiment of the present invention. In addition, the EL display apparatus 100E in the sixth embodiment described above corresponds to also a display apparatus provided by an embodiment of the present invention.

On top of that, each of the liquid-crystal panels 200, 200c and 200e employed in the embodiments described above corresponds to a display panel provided by an embodiment of the present invention. In addition, the EL panel 200E in the sixth embodiment described above corresponds to an EL panel provided by an embodiment of the present invention.

On top of that, the TFT array substrate 201 employed in the embodiments described above corresponds to the first substrate provided by an embodiment of the present invention whereas the facing substrate 202 employed in the embodiments described above corresponds to the second substrate provided by an embodiment of the present invention. In addition, the liquid-crystal layer 203 employed in the embodiments described above corresponds to a liquid-crystal layer provided by an embodiment of the present invention.

On top of that, each of the backlights 300, 300b and 300c employed in the embodiments described above corresponds to an illumination unit/apparatus provided by an embodiment of the present invention. In addition, the light source 301 employed in the embodiments described above corresponds to a light source provided by an embodiment of the present invention whereas the light guiding board 302 employed in the embodiments described above corresponds to a light guiding board provided by an embodiment of the present invention.

On top of that, the visible light source 301a employed in the embodiments described above corresponds to a visible light source provided by an embodiment of the present invention. In addition, the infrared light source 301b employed in the embodiments described above corresponds to an invisible light source provided by an embodiment of the present invention.

On top of that, the light reflection film 304 employed in the embodiments described above corresponds to a light reflection section provided by an embodiment of the present invention or, strictly speaking, an invisible light reflection section provided by an embodiment of the present invention.

In addition, the infrared light beam reflection layer 305 employed in the embodiments described above corresponds to an invisible light beam reflection layer/section provided by an embodiment of the present invention. On top of that, the diffraction lattice section 305KK in the second embodiment described above corresponds to a light diffraction lattice section provided by an embodiment of the present invention or an invisible light beam reflection section provided by an embodiment of the present invention.

In addition, the biometric authentication section 402 employed in the embodiments described above corresponds to a biometric authentication section provided by an embodiment of the present invention.

On top of that, each of the front-lights 500 and 500d employed in the embodiments described above corresponds to an illumination unit/apparatus provided by an embodiment of the present invention. In addition, the light source 501 employed in the embodiments described above corresponds to a light source provided by an embodiment of the present invention whereas each of the light guiding boards 502 and 502d employed in the embodiments described above corresponds to a light guiding board provided by an embodiment of the present invention.

On top of that, the infrared light source 501b employed in the embodiments described above corresponds to an invisible light source provided by an embodiment of the present invention.

In addition, the infrared light beam reflection layer 505 employed in the embodiments described above corresponds to an invisible light beam reflection layer/section provided by an embodiment of the present invention. On top of that, the prism surface 505P in the fourth embodiment described above corresponds to a prism surface provided by an embodiment of the present invention or an invisible light beam reflection section provided by an embodiment of the present invention.

In addition, the pixel area PA employed in the embodiments described above corresponds to a pixel area provided by an embodiment of the present invention whereas the pixel P employed in the embodiments described above corresponds to a pixel provided by an embodiment of the present invention. On top of that, the photo sensor device 32a employed in the embodiments described above corresponds to a photo sensor device provided by an embodiment of the present invention.

What is claimed is:

1. A display apparatus comprising:
a display panel including a plurality of pixels laid out on the surface of a pixel area of said display panel; and
an illumination section configured to generate illumination light in a normal direction perpendicular to said display panel, wherein
said illumination section has
a light source for radiating original light and
a light guiding board which is exposed to a surface of said display panel,
said original light generated by said light source hits an incidence surface of said light guiding board and said original light hitting said incidence surface is guided to a radiation surface of said light guiding board to be radiated from said radiation surface as said illumination light,
said display panel also includes
a plurality of photo sensor devices also arranged in said pixel area to serve as devices each used for receiving incoming light propagating in a direction parallel to the direction from a front-surface side of said display panel to a rear-surface side of said display panel and functions as a panel configured to display an image in said pixel area on said front-surface side,
said light source includes
an invisible light source for generating an invisible light beam as said original light,
said light guiding board includes
an invisible light beam reflection section configured to reflect said invisible light beam generated by said invisible light source in a direction parallel to said direction from said rear-surface side of said display panel to said front-surface side of said display panel,
said invisible light beam reflection section is provided at a location corresponding to an area included in said pixel area in which said photo sensor devices are created, and
said invisible light beam reflected by said invisible-light beam reflection section is radiated from said radiation surface of said light guiding board as said illumination light.

2. The display apparatus according to claim 1 wherein said invisible light source generates an infrared light beam as said invisible light beam.

3. The display apparatus according to claim 2, said display apparatus further employing:
a biometric authentication section configured to authenticate a biological subject located on said front-surface side of said display panel, wherein
said biological subject reflects said illumination light, which has been generated by said illumination section, in said direction parallel to said direction from said front-surface side of said display panel to said rear-surface side of said display panel,
said photo sensor devices receive said reflected illumination light as said incoming light and generate received-light data from said reflected illumination light, and
said biometric authentication section authenticates said biological object on the basis of said received-light data.

4. The display apparatus according to claim 3 wherein said photo sensor devices generate said received-light data by receiving said reflected light reflected from said illumination light reflected by blood flowing in said biological subject.

5. The display apparatus according to claim 4 wherein said display panel employs:
a first substrate provided on said rear-surface side;
a second substrate exposed to said first substrate and separated away from said first substrate by a gap; and
a liquid-crystal layer provided in said gap sandwiched by said first and second substrates to serve as a layer including uniformly oriented liquid-crystal molecules.

6. The display apparatus according to claim 5 wherein said illumination section is provided on said rear-surface side of said display panel.

7. The display apparatus according to claim 6 wherein
said display panel is a transmission-type liquid-crystal panel,
said illumination section includes
a visible light source for generating a visible light beam, and
said light guiding board guides said visible light beam, which is radiated by said visible light source to said incidence surface, and said invisible light beam, which is radiated by said invisible light source to said incidence surface, to said radiation surface as said illumination light in order to display an image in said pixel area of said display panel functioning as said transmission-type liquid-crystal panel.

8. The display apparatus according to claim 7 wherein said invisible light beam reflection section has an invisible light beam reflection layer including an invisible light beam reflection pigment for reflecting said invisible light beam.

9. The display apparatus according to claim 8 wherein said invisible light beam reflection section includes
a plurality of said invisible light beam reflection layers created at a location corresponding to an area included in said pixel area, in which said photo sensor devices are created, by separating said invisible light beam reflection layers from each other.

10. The display apparatus according to claim 7 wherein said invisible light beam reflection section employs
a diffraction lattice section configured to diffract said invisible light beam and
a reflection section configured to reflect said invisible light beam diffracted by said diffraction lattice section.

11. The display apparatus according to claim 10 wherein said invisible light beam reflection section includes
a plurality of said diffraction lattice sections created at a location corresponding to an area included in said pixel area, in which said photo sensor devices are created, by separating said diffraction lattice sections from each other.

12. The display apparatus according to claim 5 wherein said illumination section is provided on said front-surface side of said display panel.

13. The display apparatus according to claim 12 wherein said invisible light beam reflection section includes
a prism surface configured to reflect said invisible light beam generated by said invisible light source in said direction parallel to said direction from said rear-surface side of said display panel to said front-surface side of said display panel.

14. The display apparatus according to claim 12 wherein said invisible light beam reflection section has
an invisible light beam reflection layer including an invisible light beam reflection pigment for reflecting said invisible light beam.

15. The display apparatus according to claim 14 wherein said invisible light beam reflection section includes
a plurality of said invisible light beam reflection layers created at a location corresponding to an area included in said pixel area, in which said photo sensor devices are created, by separating said invisible light beam reflection layers from each other.

16. The display apparatus according to claim 12 wherein said display panel is a liquid-crystal panel of a reflection type.

17. The display apparatus according to claim 3 wherein said display panel make is an EL (Electro Luminescence) panel.

18. An illumination apparatus employing:
an illumination section configured to generate illumination light in a normal direction perpendicular to a display panel provided with a plurality of pixels, which are laid out on the surface of a pixel area, and provided with a plurality of photo sensor devices, which are also arranged in said pixel area to serve as devices each used for generating received-light data by receiving incoming light propagating in a direction parallel to a direction from a front-surface side of said display panel to a rear-surface side of said display panel, to serve as a panel configured to display an image on said front-surface side, wherein
said illumination section has
a light source for radiating original light and
a light guiding board which is exposed to a surface of said display panel so as to direct said original light generated by said light source to hit an incidence surface and guide said original light hitting said incidence surface to a radiation surface to be radiated from said radiation surface as said illumination light,
said light source includes
an invisible light source for generating an invisible light beam as said original light,
said light guiding board includes
an invisible light beam reflection section configured to reflect said invisible light beam generated by said invisible light source in a direction parallel to a direction from said rear-surface side of said display panel to said front-surface side of said display panel,
said invisible light beam reflection section is provided at a location corresponding to an area included in said pixel area in which said photo sensor devices are created, and
said invisible light beam reflected by said invisible-light beam reflection section is radiated from said radiation surface as said illumination light.
